(19) United States
(12) Patent Application Publication
(10) Pub. No.: US 2025/0086985 A1
(43) Pub. Date: Mar. 13, 2025

(54) METHODS AND SYSTEMS FOR ROAD CONDITION ASSESSMENT AND FEEDBACK

(71) Applicant: Purdue Research Foundation, West Lafayette, IN (US)

(72) Inventors: Mohammad Reza Jahanshahi, West Lafayette, IN (US); Yu-Ting Huang, West Lafayette, IN (US)

(73) Assignee: Purdue Research Foundation, West Lafayette, IN (US)

(21) Appl. No.: 18/884,032

(22) Filed: Sep. 12, 2024

Related U.S. Application Data
(60) Provisional application No. 63/537,888, filed on Sep. 12, 2023.

(51) Int. Cl. G06V 20/56; G01N 21/956; G01S 19/14; G06T 7/00; G06V 20/10

(52) U.S. Cl. CPC G06V 20/588; G01N 21/956; G01S 19/14; G06T 7/0006; G06V 20/176; G06T 2207/10028

(57) ABSTRACT

A method for managing road defects includes capturing images and depth information from a roadway using a first vision system, identifying position of the captured images, processing the captured images by a processing system to i) detect, and ii) classify one or more types of road defects, quantifying the one or more types of road defects to thereby generate quantification parameters by the processing system, and scoring the severity of each of the one or more types of road defects using the processing system that includes a predetermined rule-based scorer based on the generated quantified parameters of the one or more types of road defects.

### CROSS-REFERENCE TO RELATED APPLICATIONS

The present non-provisional patent application is related to and claims the priority benefit of U.S. Provisional Patent Application Ser. 63/537,888, filed Sep. 12, 2023, the contents of which are hereby incorporated by reference in its entirety into the present disclosure.

### STATEMENT REGARDING GOVERNMENT FUNDING

None.

### TECHNICAL FIELD

The present disclosure generally relates methods and systems used to detect roadway defects, and in particular an automated method and system that can detect, classify, and quantify road defects as well as automatically provide feedback recommendations for how to address the defects.

### BACKGROUND

This section introduces aspects that may help facilitate a better understanding of the disclosure. Accordingly, these statements are to be read in this light and are not to be understood as admissions about what is or is not prior art.

The assessment of road conditions is of utmost importance in ensuring the safety and efficiency of transportation infrastructure. However, current methods of evaluation suffer from subjectivity, delayed response, and high costs due to human labor costs.

According to the latest report card released by the American Society of Civil Engineers (ASCE) in 2021, over 40% of roads in the United States are in poor or mediocre condition. These poor pavement conditions result in significant costs for repairs. However, it is possible to rehabilitate the pavement at a lower cost if periodic maintenance is carried out at the early stage of deterioration and inspections are more frequent.

To enhance the effectiveness of pavement management, various methods have been developed. The pavement management system includes two levels: network level and project level. At the network level, the evaluation of pavement conditions aims to optimize the allocation of funds for rehabilitation and maintenance across the entire network. On the other hand, at the project level, the evaluation of pavement conditions is crucial for determining the optimal approach for constructing or rehabilitating a specific section of roadway.

Several indices have been designed and used for pavement condition evaluation. The Pavement Condition Index (PCI), originally introduced by the United States Army Corps of Engineers, utilizes a numerical scale ranging from 0 to 100 to assess the condition of pavements. A higher value on this scale indicates a better overall condition, with 100 representing the best possible condition. The PCI is derived from a visual inspection process and the calculated index provides a comprehensive evaluation of its condition. Another widely accepted index for evaluating road conditions is the International Roughness Index (IRI). This index provides a quantitative measure of ride quality and pavement roughness, allowing for the comparison of various road sections and long-term performance monitoring. In addition to the IRI and PCI, the PASER system is extensively used for visually assessing pavement conditions on a scale of 1 to 10. Under this system, a score of 1 signifies the worst condition, while a score of 10 indicates the best condition. Traditionally, trained personnel conduct visual inspections to determine these ratings. Some Department of Transportation (DOTs) also use Present Serviceability Rating (PSR) and Present Serviceability Index (PSI). The concept of the PSR, which was first introduced during the AASHO Road Test studies, involves a thorough evaluation by an expert to determine a pavement's current capability to adequately accommodate traffic, considering its ride quality. The PSR scale ranges from 5, indicating perfection, to 0, signifying the worst condition. Meanwhile, the PSR forms the foundational basis for the derivation of the PSI, a mathematical function that relies on correlated PSR values. Furthermore, both the PCI and the PASER can be converted to PSR values.

However, the implementation of these methods presents practical challenges. Firstly, the visual-based inspection and rating approaches are subjective and do not have the capability to quantify defects or account for variations. Consequently, the ratings can differ among inspectors and provide limited insight into detailed distress information. Conversely, the IRI focuses on evaluating ride quality based on the wheel path, but it lacks a comprehensive assessment of road conditions. Additionally, the current practices for assessing pavement conditions are expensive and time-consuming, as they are typically conducted only once every one or two years. This frequency poses a difficulty in accurately reflecting the deterioration of pavement conditions in a timely manner, particularly considering that rehabilitation plans often span over a period of 5 to 20 years.

Therefore, there is an unmet need for a novel completely automated or semi-automated method and system capable of continuously or semi-continuously inspecting roadway conditions for defects, classifying the defects, quantifying the defects, and optionally providing feedback on how to best address the defects.

### SUMMARY

A system for managing road defects is disclosed which includes a first vision system. The first vision system includes at least one image capture device adapted to capture images of a roadway having a plurality of pixels for each image, at least one depth sensor adapted to provide depth information for each pixel in the captured images, and a positioning sensor adapted to generate location information for each captured image. The system further includes a processing system having at least one processor adapted to execute instructions maintained on a non-transient memory. The processing system is adapted to receive one or more captured images, analyze the one or more captured images to thereby i) detect, and ii) classify one or more types of road defects from a plurality of predetermined road defects, quantify the detected and classified one or more types of road defects to thereby generate quantified parameters associated with each of the one or more types of road defects, and score severity of each of the one or more types of road defects using a predetermined rule-based scorer based on the generated quantified parameters of the one or more types of road defects.

A method for managing road defects is also disclosed. The method includes capturing images and depth information from a roadway using a first vision system. The method further includes identifying position of the captured images. Additionally, the method includes processing the captured images by a processing system to i) detect, and ii) classify one or more types of road defects. Yet still, the method includes quantifying the one or more types of road defects to thereby generate quantification parameters by the processing system. The method also includes scoring the severity of each of the one or more types of road defects using the processing system that includes a predetermined rule-based scorer based on the generated quantified parameters of the one or more types of road defects.

### BRIEF DESCRIPTION OF FIGURES

The patent or application file contains at least one drawing executed in color. Copies of this patent or patent application publication with color drawing(s) will be provided by the Office upon request and payment of the necessary fee.

FIG. 1a is a block diagram providing the basic blocks involved in the system of the present disclosure.

FIG. 1b is a photograph of two red-green-blue (RGB)-depth (RGB-D) sensors, where one or both are used in the system of the present disclosure.

FIG. 1c is a photograph of a global position system (GPS) sensor, used in the present disclosure.

FIG. 1d is a photograph of a sub-processing board utilized for processing the RGB sensor and depth sensor data.

FIG. 2, which is a more detailed block diagram showing various connectivity between two RGB-D sensors, a GPS receiver, a powered USB hub, the processing board shown in FIG. 1d, and a solid-state drive (SSD).

FIGS. 3a and 3b provide photographs of two RGB-D sensors attached to a vehicle as proof of concept, where the sensors are about 1.4 m apart and are about 1.4 m above the roadway surface.

FIGS. 4a, 4b, 4c, 5a, 5b, and 5c are examples photographs of road defects from two RGB-D cameras as shown in FIGS. 4a, 4b, 5a, and 5b, where the images are stitched together to generate FIGS. 4c and 5c, respectively.

FIGS. 6a, 6b are photographs of roadway defects.

FIGS. 6c and 6d are images providing depth information for FIGS. 6a and 6b, respectively.

FIG. 7 is a block diagram depicting major data processing blocks of the methods of the present disclosure.

FIGS. 8a, 8b, 8c, and 8d provide example quantification flowcharts that establish a PASER score from the classified road defect.

FIGS. 9a, 9b, 9c, 9d, 9e, 9f, 9g, 9h, 10a, 10b, 10c, 10d, 10e, 10f, 10g, and 10h provide example of roadway defects classes that are detected and classified by a classifier.

FIG. 11a is a flowchart that provides steps in the processing of the present disclosure from receiving RGB images along with depth information, providing the RGB image to an image transformer (e.g., a Swin transformer—see FIGS. 11a and 11b) for detection and classification of road defects, if there is a road defect is a crack, then providing the RGB image to a neural network or machine learning (e.g., a U-Net—see FIG. 11d) to generate a mask and then using the mask to quantify the crack; if the road defect is a pothole, then providing the RGB image and depth information to a quantifier to quantify the pothole, and providing all of the above information (i.e., whether there is a road defect, if a crack then quantified information about the crack, if a pothole then quantified information about the pothole) to a scorer (e.g., a scoring algorithm based on predetermined rules (e.g., a PASER algorithm—see FIGS. 8a, 8b, 8c, and 8d)) to provide a score and then automatically provide feedback to a user for how to manage the road condition.

FIGS. 11b and 11c are block diagrams of an image transformer (e.g., a Swin transformer) that receives RGB images and detects road defects if any including cracks (e.g., transversal, longitudinal, spider) and potholes as well as other road conditions (e.g., a manhole) and classifies each road defect, accordingly.

FIG. 11d is a schematic of a machine learning system (e.g., a U-Net neural network) for generating a mask if the road defect is a crack.

FIGS. 12a, 12b, 12c, 12d, and 12e are photographs in which center-line estimation according to the present disclosure of the crack is shown, where for each crack the centerline is drawn out.

FIGS. 13a, 13b, 13c, and 13d demonstrate the side-by-side comparison between the ground truth and segmentation mask output generated by a U-Net model.

FIGS. 14a and 14b are bar graphs that provide estimations for the average and maximum crack width, allowing for a comprehensive comparative analysis among the segmentation masks obtained directly from the U-Net model, the manually annotated outcomes, and the enhanced segmentation mask.

FIG. 15 is a photograph of a vehicle with a GoPro™ camera mounted thereon.

FIGS. 16a, 16b, 16c, and 16d are photographs that illustrate the presence of alligator cracking and edge cracks on the pavement.

FIGS. 17a and 17b is an RGB image (FIG. 17a) and a segmentation schematic (FIG. 17b) showing inaccurate segmentation results and incorrect estimations of the alligator cracking area occurred because of lighting condition.

FIG. 18 is a map showing PASER scores obtained from the system of the present disclosure which is visually depicted on the map using a color-coded scheme.

FIGS. 19a, 19b, 19c, and 19d are photographs depicting evolution of a road defect.

FIGS. 20a, 20b, 20c, 20d, 21a, 21b, 21c, 21d, 22a, 22b, 22c, 23a, 23b, and 23c are additional photographs showing evolution of road defects, e.g., a pothole where the top first row in each figure provides the RGB image and the second row in each figure provides the depth information.

FIGS. 24a, 24b, 24c, and 24d provides graphs of maximum depth vs. date for the potholes shown in FIGS. 20a, 20b, 20c, 20d, 21a, 21b, 21c, 21d, 22a, 22b, 22c, 23a, 23b, and 23c.

FIGS. 25a, 25b, and 25c are additional RGB-D image pairs with the first row showcasing RGB images and the second row displaying depth information.

FIG. 26 is a block diagram of a computer system that can interface with the system of the present disclosure.

### DETAILED DESCRIPTION

For the purposes of promoting an understanding of the principles in the present disclosure, reference will now be made to the embodiments illustrated in the drawings, and specific language will be used to describe the same. It will nevertheless be understood that no limitation of the scope of this disclosure is thereby intended.

In the present disclosure, the term “about” can allow for a degree of variability in a value or range, for example, within 10%, within 5%, or within 1% of a stated value or of a stated limit of a range.

In the present disclosure, the term “substantially” can allow for a degree of variability in a value or range, for example, within 90%, within 95%, or within 99% of a stated value or of a stated limit of a range.

A novel completely automated or semi-automated method and system capable of continuously or semi-continuously inspecting roadway conditions for defects, classifying the defects, quantifying the defects, and optionally providing feedback on how to best address the defects is provided herein.

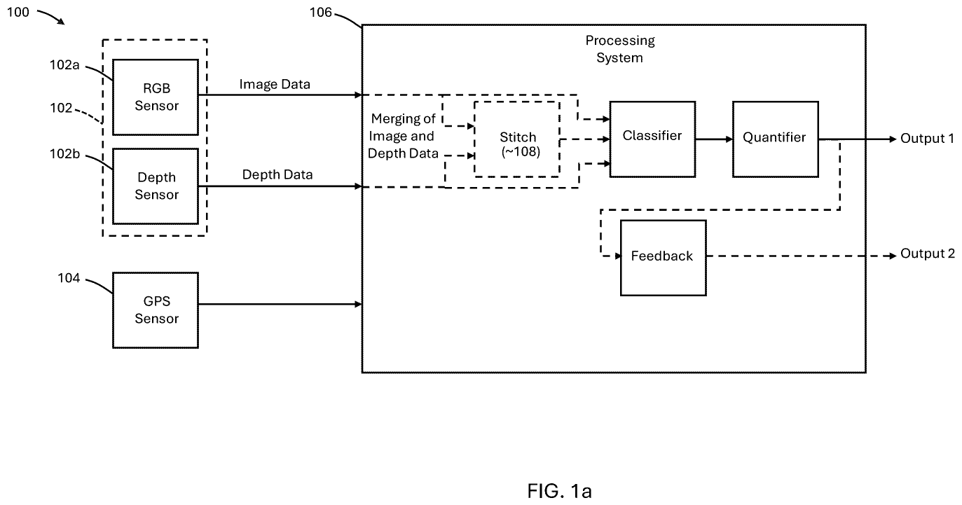

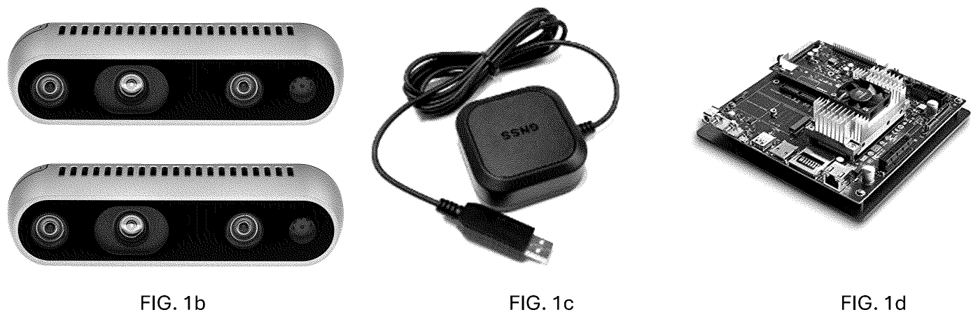

Towards this end, the present disclosure provides a completely automated or semi-automated system that utilizes at least one color camera (e.g., a red-green-blue (RGB) camera) and at least one depth sensor (e.g., a depth camera, e.g., an RGB-D camera, a radar-based sensor, a sonar-based sensor, or a lidar-based sensor) to comprehensively and efficiently assess road conditions. The system includes a cost-effective data acquisition system that can be installed on multiple vehicles, allowing for the collection of pavement surface data on a weekly basis. The vehicles can be wheeled vehicles or aerial vehicles driven or operated by human operators, thus making the system a semi-automated roadway defect detection systems or by a wheeled drone vehicle or an unmanned aerial drone vehicle, thus making the system completely automated and autonomous. In addition, a crowdsourcing topology can be implemented wherein the system shown in FIG. 1a is coupled to a plurality of vehicles driving throughout an urban or a non-urban area and generate data that are integrated together to thereby eliminate the need for an agency to send out such vehicles. By utilizing one RGB-D sensors, the system captures both 2-dimensional (2D) color and 3-dimensional (3D) depth information of the entire lane width, with precise temporal and spatial frame registration facilitated by a high-precision global positioning system (GPS) sensor. In other word, one RGB-D sensor is sufficient to capture information needed by the system to detect defects. Where the reach of one RGB-D camera is insufficient to capture the entire lane, two RGB-D sensors can be used whose outputs are stitched together based on a priori knowledge of edge reach of each sensor and using the known overlap between the two RGB-D sensors to generate color and depth information of one complete lane. To evaluate pavement conditions, pavement data classification, and quantification are conducted as provided in the present disclosure. The pavement surface data is classified into eight classes, including healthy surface, open joint, manhole, crack sealant, transverse crack, longitudinal crack, alligator cracking, and pothole. Moreover, the quantification results provide detailed information on distress and offer a more accurate understanding of pavement conditions. The method of the present disclosure can accommodate various visual-based pavement evaluation approaches including Pavement Surface and Evaluation Rating (PASER) for asphalt pavements is selected as a case study. The system also tracks the progression of detected defects and repair work, providing real-time insights into pavement deterioration and maintenance. Real-time updates on road conditions enable effective planning and resource allocation for pavement maintenance and rehabilitation. Thus, the method and system of the present disclosure serves as a foundation for enhancing pavement management strategies and optimization. The disclosed system is used for data collection with traffic speed and extensively evaluated to demonstrate its capabilities. The autonomous or semi-autonomous road condition evaluation system of the present disclosure paves the way for safer and more efficient pavement management, benefiting road users and communities at large.

Reference is made to FIG. 1a which is a block diagram providing the basic blocks involved in the system 100 of the present disclosure. As shown in FIG. 1, at least one RGB sensor 102a is used along with at least one depth sensor 102b. Additionally, a global positioning system (GPS) sensor 104 provides position information used by the processing system 106 to identify position of images captured by the image capture device. However, it should be appreciated that the at least one RGB sensor and the at least one depth sensor can be integrated into one RGB-D sensor 102, e.g., INTEL® RealSense™ RS-D435 RGB-D sensor. Where such cameras are not able to cover the entire lane of a roadway, two of each RGB/depth sensors can be used where the outputs with a priori knowledge of edge locations can be used to stich the RGB and depth information for data processing of the entire lane as provided in the stitching block 108, as would be known to a person having ordinary skill in the art. Regardless, image and depth data are merged in the processing system 106 to thereby generate a complete understanding of the roadway conditions. Examples of the RGB-D sensors used in system of the present disclosure is provided in FIG. 1b which is a photograph of two red-green-blue (RGB)-depth (RGB-D) sensors, where one or both are used in the system of the present disclosure. Referring to FIG. 1c, a photograph of a global position system (GPS) sensor, e.g., TOP608BT High Precision USB/Bluetooth GNSS Receiver (ZED-F9P multi-band RTK, with up to 1.4 cm accuracy when connected to a Networked Transport of Radio Technical Commission for Maritime Services (RTCM) via Internet Protocol (NTRIP) caster) is provided that is used in the present disclosure. Referring to FIG. 1d, a photograph of a sub-processing board (e.g., NVIDIA® Jetson™ TX2) is provided which is utilized for processing the RGB sensor and depth sensor data.

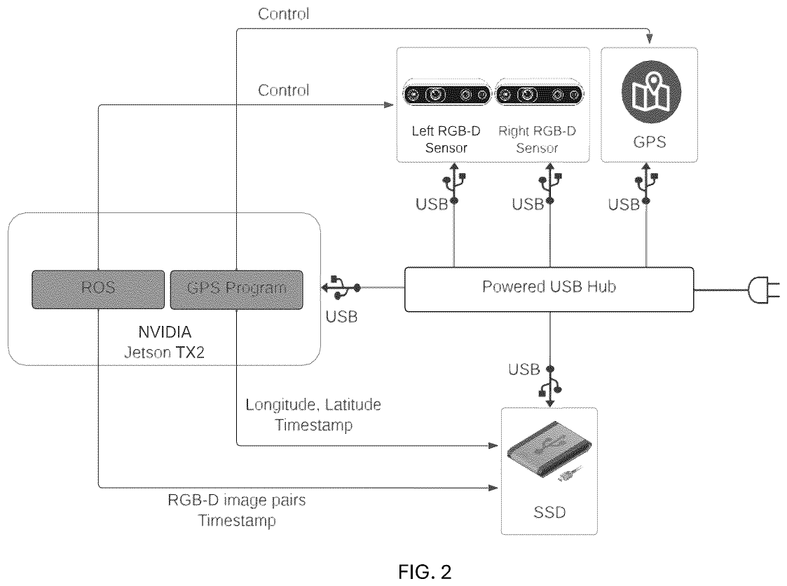

As discussed above, when one RGB-D sensor is insufficient to cover an entire lane, two such RGB-D sensors may be used where their output data are stitched together to generate an RGB image and depth information for the entire lane. Robotic Operating System (ROS), which is a framework that facilitates the programming of robots for inter-process communication, is used to interconnect the hardware components and provide an interface for top-down control in the system. To accommodate the substantial volume of images, a portable 1-TB universal serial bus (USB) solid-state drive (SSD) device is employed for efficient archival purposes. The overall architecture of the developed data acquisition is shown in FIG. 2, which is a more detailed block diagram showing various connectivity between the two RGB-D sensors, the GPS receiver, a powered USB hub, the processing board shown in FIG. 1d, and the SSD.

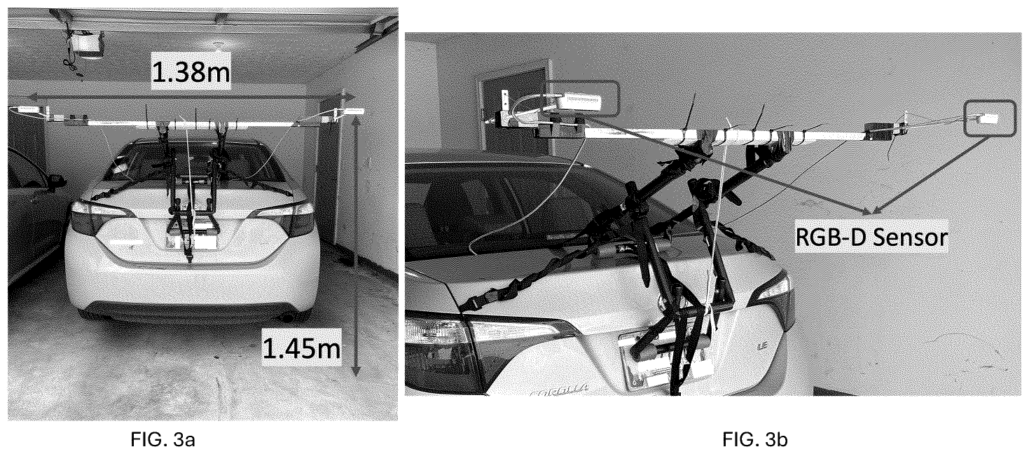

FIGS. 3a and 3b provide photographs of two RGB-D sensors attached to the rear of a vehicle as proof of concept, where the sensors are about 1.4 m apart and are about 1.4 m above the roadway surface. The setup shown in FIGS. 3a and 3b provide consistent positioning throughout data collection. It is important to recognize that the mounting mechanism serves as a proof of concept in the present disclosure. A number of other mounting mechanisms can be employed which are within the skillset of a person having ordinary skill in the art. Moreover, the system has been designed to operate with energy efficiency, enabling it to function solely using the vehicle's 12 V supply (e.g., the 12 V provided by a lighter). This eliminates the need for additional power sources, making it more flexible for different types of vehicles.

While not shown a similar setup can be provided for the front of the vehicle where data from the two sets of sensors can be used in a differential manner, particularly when roadway defects are closer in proximity than the length of the vehicle. In this way, the system recognizes road defects as they first appear in the front of the vehicle and the same road defects appear in the rear of the vehicle and thus translational motion of the vehicle due to encounter with said road defect can be taken into account when determining depth and size of the defect, as discussed further below.

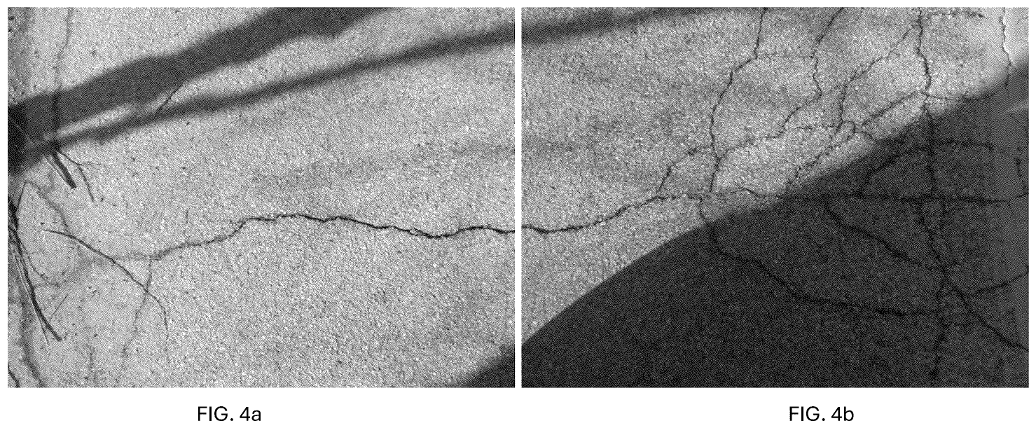

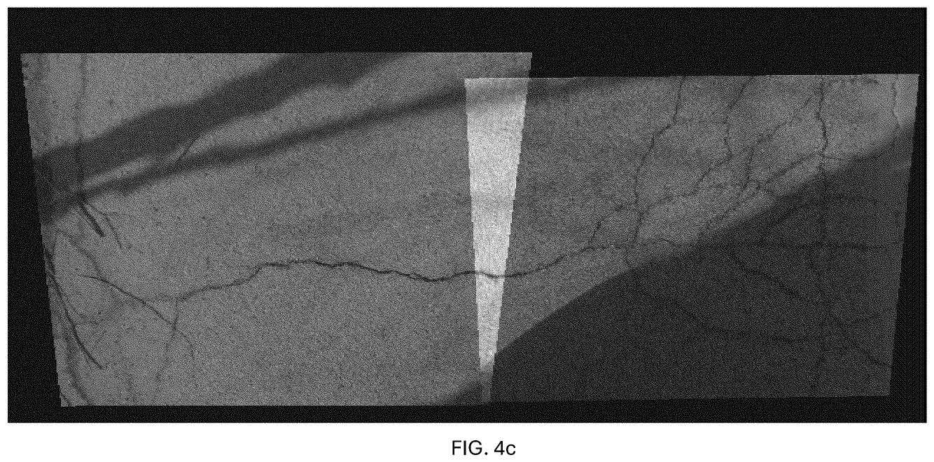

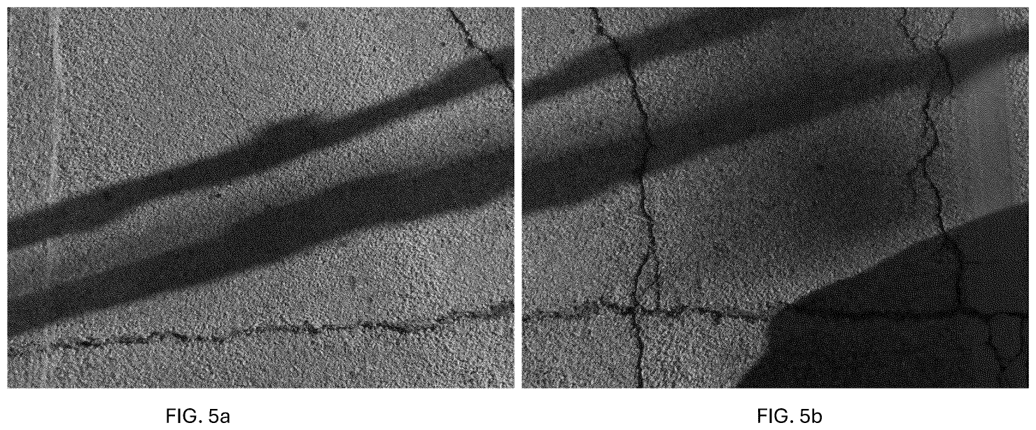

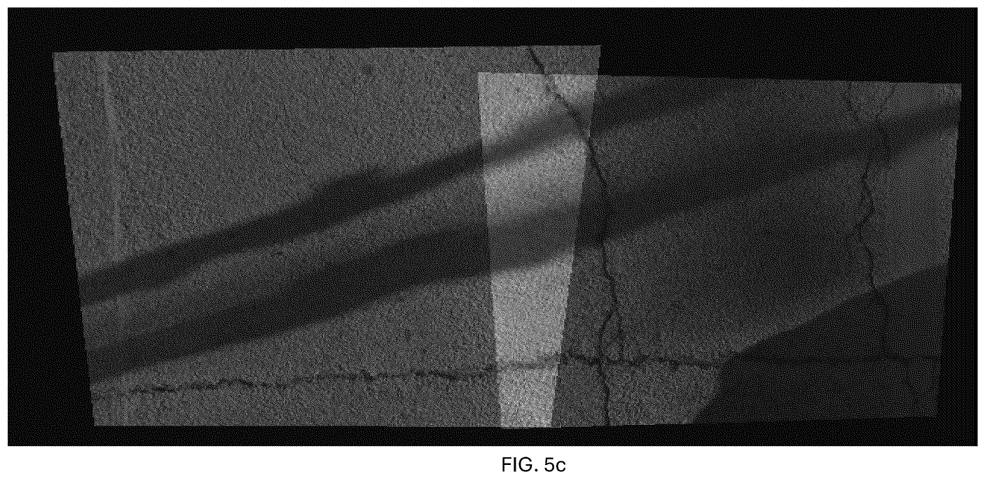

Examples of the road defects from two such RGB-D cameras are shown in FIGS. 4a, 4b, 5a, and 5b, where the images are stitched together to generate FIGS. 4c and 5c, respectively. Referring to FIGS. 4c and 5c, highlighted triangles represent overlap between FIGS. 4a and 4b, and 5a, and 5b, respectively, used for stitching the corresponding images.

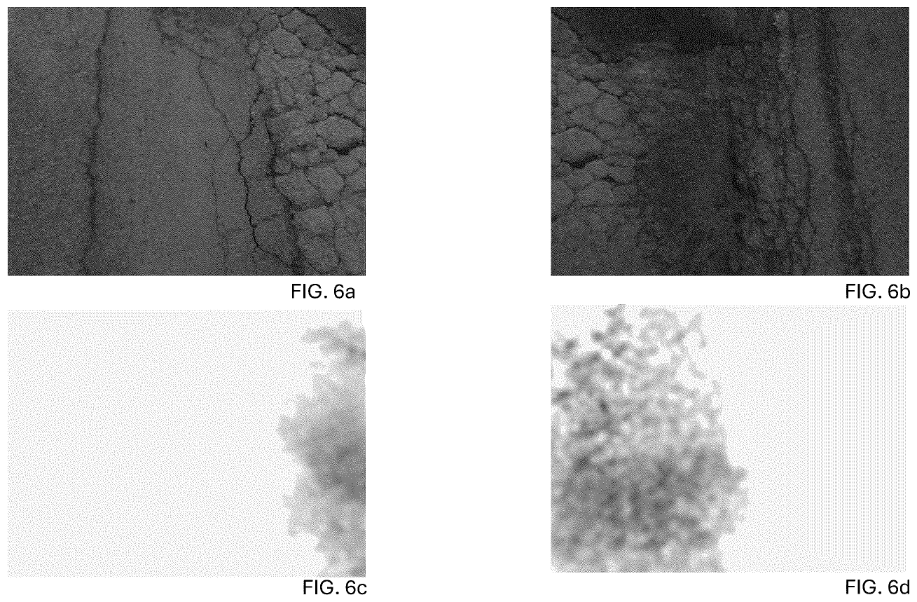

Referring to FIGS. 6a, 6b, photographs of roadway defects are shown which correspond to depth information shown in FIGS. 6c and 6d, respectively. The system of the present disclosure, as provided in FIGS. 6a-6d is capable of photographing and acquiring depth information where the road surface exhibits significant alligator cracking alongside a perceptible depression. This example effectively emphasizes the complementary nature of depth information when combined with the RGB image.

The example setup shown in FIGS. 3a and 3b can be used for regular drives over city roads, maintaining speeds of 30 to 40 mph, with the objective of collecting RGB-D pavement surface data. The frame rate per second (FPS) of 30 is used for both the RGB and depth sensors, while the resolution of the captured RGB and depth images is set at 640×480 pixels, ensuring an optimal balance between image quality and data storage requirements; however, other resolutions are within the ambit of the present disclosure. The RGB images are stored in Joint Photographic Experts Group (JPEG) format, while the depth images are stored in Portable Network Graphic (PNG) format. To establish synchronization between the obtained RGB-D image pairs and their corresponding GPS coordinates, a Unix timestamp is utilized as the standardized nomenclature for all dataset files. In an actual reduction to practice, the system was mounted on a vehicle, which was then operated on the local streets of West Lafayette in Indiana several times a week, to collect pavement surface data. Based on one embodiment, the system has the capability to acquire approximately 3,600 pairs of RGB-D images per mile for each RGB-D sensor.

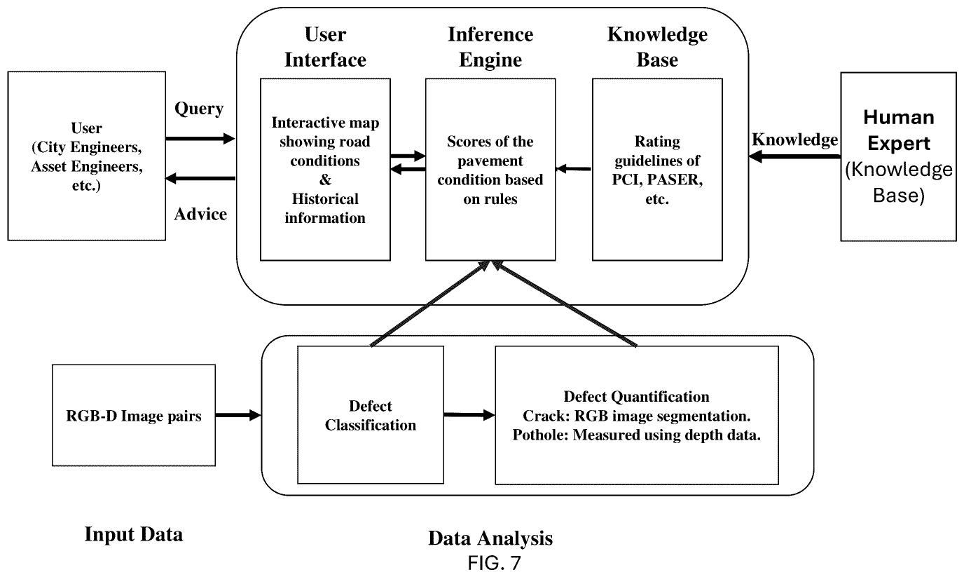

FIG. 7 is a block diagram depicting major data processing blocks of the methods of the present disclosure. In FIG. 7, a user (e.g., a city roadway engineer) queries the system of the present disclosure. The system provides a user interface in which an interactive map of the roadway are provided with real RGB and depth images showing road defects for a queried roadway section. The interactive map may also provide historical information as well as an overall score which can be a statistical measure of the roadway section (e.g., an average score of sub-sections of the queried road section). The score for each sub-section of the roadway is calculated in the inference engine where pre-determined rules (e.g., Paser rules) are used to determine a score of each defect, as discussed below. The rules are provided from a knowledge base (e.g., Paser) identified as coming from a Human Expert. These are simply predetermined rules that can be applied to each defect that is displayed on the interactive map in the user interface based on 1) the classification of said defect, and 2) based on the quantification of the defect, as provided in FIG. 7, and further discussed below. In short, a classifier engine receives the RGB images along with the corresponding depth information and classifies the road defect as one of many classes (e.g., pothole, spider cracks, manhole, etc.). This classification for each road defect is then provided to a quantification engine to determine exact parameter associated with the defect. These quantified parameters are then used based on the predetermined ruleset (e.g., Paser) to assign a score to each road defect. Thus, each road defect receives a score. These scores can be averaged for subsections of roadway and provided to the user in response to the user inquiry. The same averaged score can also be used to provide advice in the form of a feedback to the user. For example, if the averaged score of a subsection is below a predetermined threshold, then the system of the present disclosure may advise the user to provide a complete tear-down and re-paving of the road subsection. Alternatively if one particular road defect presents a score that is below a predetermined threshold, while the entire subsection of the road may not require a complete tear down and re-paving, the system may advise said defect to be treated with a complete tear down and repaving.

Therefore, the system of the present disclosure provides an extended expert systems for detection, classification, and quantification of roadway defects. An expert system refers to a computer system that emulates the decision-making capabilities of a human expert. It utilizes explicit knowledge and reasoning, employing a rule-based methodology to draw conclusions and provide guidance. Typically an expert system receives input from a user, e.g., in the sense of the present disclosure knowledge related to road defect that is gathered by the user, and the expert system then uses a priori knowledge to provide a score related to the input provided by the user.

However, the system as shown in FIG. 7, is an extended expert system whereby the information related to road defect is not provided by a user, by generated by the system of the present disclosure in an autonomous or semi-autonomous fashion (i.e., either a completely automated wheeled or aerial drone gathers road information as discussed above, or a user operates a wheeled or aerial vehicle to automatically gather the road defect information, as discussed above). The extended expert system comprises several primary components: the defect classification which includes defect detection, defect quantification, knowledge base, and the inference engine. The knowledge base comprises a compilation of facts and rules that encompass all the knowledge related to the domain of inquiry provided to the system. The inference engine integrates the facts of a specific case with the information stored in the knowledge base to generate a recommendation. In the present disclosure, the extended expert system plays the role of a pavement assets engineer, where not only image and depth data are gathered automatically from the roadway, the extended expert system uses the knowledge base which represents the guidelines listed in various pavement assessments. The system of the present disclosure has the capacity to improve the impartiality and regularity of road inspection results, making it suitable for use with various rating criteria. Visual-based assessments involve the observation and evaluation of pavement surface defects, including cracks, potholes, rutting, and other types of deterioration. By utilizing these visual indicators, the system aids in achieving a more thorough and consistent assessment of road conditions. Thus, the system ofthe present disclosure serves as a versatile foundation for visual-based rating methodologies such as PASER, PCI, PSI, and others of similar nature. Specifically, the focus centers around the application of PASER as a representative case study. However, other similar rule-based standards such as PCI and PSI are within the ambit of the present disclosure. The PASER system is a visual-based inspection system that evaluates the condition of pavement on a scale of 1 to 10, as illustrated in Table 1.

TABLE 1
PASER scores for asphalt pavement surfaces.

| Surface | | General condition/ |
|---|---|---|
| rating | Visible distress | treatment measures |
| 10 | None | New construction. |
| Excellent | | |
| 9 | None | Recent overlay. Like |
| Excellent | | new. |
| 8 | No longitudinal cracks except a reflection | Recent sealcoat or new |
| Very | of paving joints. | cold mix. |
| Good | Occasional transverse cracks, widely spaced | Little or no |
| | (40′ or greater). | maintenance required. |
| | All cracks are sealed or tight | |
| | (open less than ¼″). | |
| 7 | Very slight or no raveling, surface shows | First signs of aging. |
| Good | some traffic wear. | Maintain 7 with |
| | Longitudinal cracks (open ¼″) due to | routine crack filling |
| | reflection or paving joints. | |
| | ♦ Transverse cracks (open ¼″) spaced 10′ | |
| | or more apart, little or slight crack | |
| | raveling. No patching or very few patches | |
| | in excellent condition. | |
| 6 | Slight raveling (loss of fines) and traffic wear. | Shows signs of aging. |
| Good | Longitudinal cracks (open ¼″-½″). | Sound structural |
| | ♦ Transverse cracks (open ¼″-½″), some | condition. Could extend |
| | spaced less than 10′. First sign of block cracking. | life with sealcoat. |
| | Sight to moderate flushing or polishing. | |
| | Occasional patching in good condition. | |
| 5 | Moderate to severe raveling (loss of fine and | Surface aging. Sound |
| Fair | coarse aggregate). | structural condition. |
| | ♦ Longitudinal cracks near | Needs seal coat or thin |
| | pavement edge. Transverse | non-structural overlay |
| | cracks (open ½″ or more) | (less than 2″) |
| | signs of slight raveling and secondary cracks. | |
| | First signs of longitudinal Block cracking up | |
| | to 50% of the surface. | |
| | Extensive to severe flushing or polishing. | |
| | Some patching or edge | |
| | wedging in good condition. | |
| 4 | Severe surface raveling. | Significant aging |
| Fair | ♦ Longitudinal cracking in the wheel path. | and first signs |
| | Block cracking (over 50% of the surface). | of need for |
| | Patching in fair condition. | strengthening. Would |
| | Slight rutting or distortions (½″ | benefit from a structural |
| | deep or less). | overlay (2″ or more). |
| 3 | Closely spaced longitudinal and transverse cracks | Needs patching and |
| Poor | often showing raveling and crack erosion. ♦ Severe | repair prior to major |
| | block cracking and some alligator cracking (less than | overlay. Milling and |
| | 25% of the surface). Patches in fair to poor condition. | removal of deterioration |
| | ♦ Moderate rutting or distortion (greater than | extends the life of |
| | ½″ but less than 2″ deep). | overlay. |
| | Occasional potholes. | |
| 2 | ♦ Alligator cracking (over 25% of surface). | Severe deterioration. |
| Very Poor | ♦ Severe rutting or distortions (2″ | Needs reconstruction |
| | or more deep). Extensive patching | with extensive |
| | in poor condition. | base repair. |
| | Potholes. | Pulverization of old |
| | | pavement is effective. |
| 1 | Severe distress with extensive loss | Failed. Needs total |
| Failed | of surface integrity. | reconstruction. |

♦ denotes priority distress.

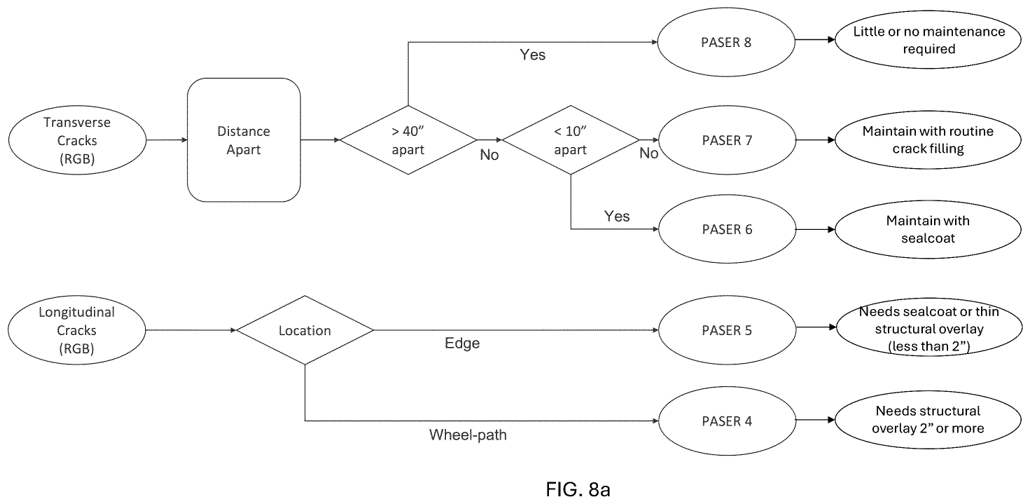

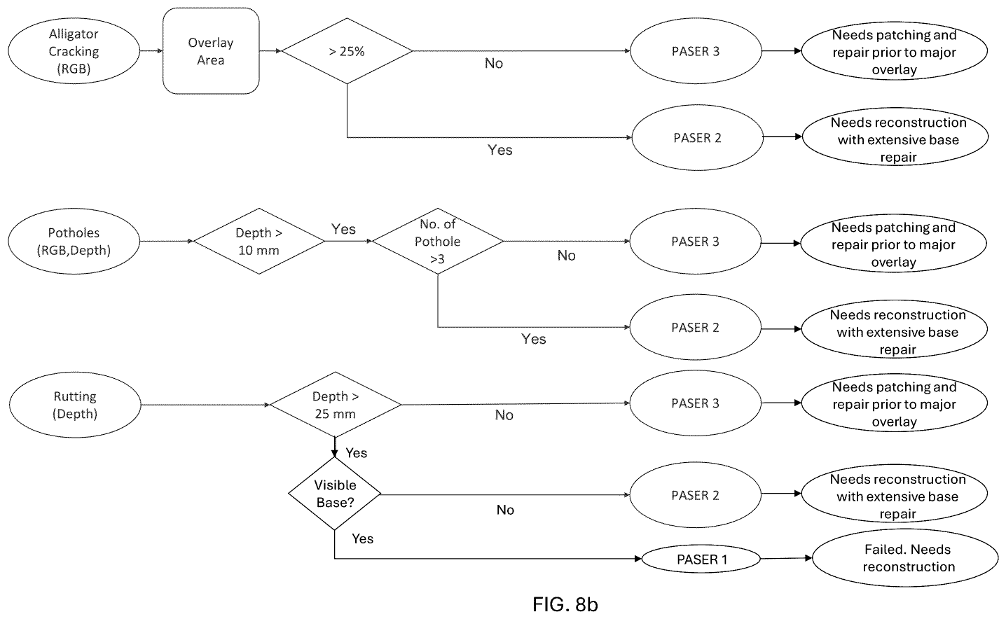

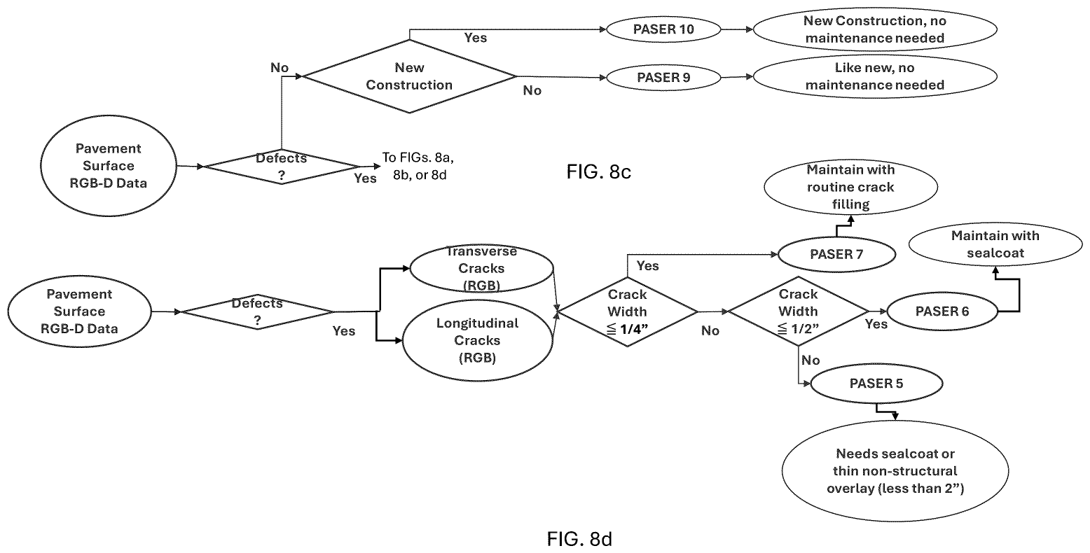

In the PASER scoring scale, a score of 1 represents the worst condition, while a score of 10 represents the best condition. This system meticulously adheres to the standard guidelines established by Asphalt PASER, ensuring a consistent and reliable scoring process when applied to the classified pavement surface data. The knowledge representation of various pavement condition guidelines can be formulated as If-THEN-ELSE rules to distinguish the condition of the roads. As illustrated in FIGS. 8a-8d flowcharts are developed to streamline the rating process in alignment with the Asphalt PASER guidelines.

The flowchart outlines the knowledge base for classifying various pavement defects based on the data collected from the pavement surface and quantifying the width of cracks. The details of the approaches for defect classification and quantification are provided below. Additionally, the GPS system contributes trajectory information and corresponding coordinates for a given vehicle, facilitating precise localization and mapping of the collected data. To this end, the Haversine formula, as denoted by Eqs. 1 to 3, is employed to calculate the distance (d) between two points on the surface of a sphere based on their latitude and longitude coordinates.

$$a = {sin}^{2} ( \frac{Δφ}{2} ) + cos {φ}_{1} \cdot cos {φ}_{2} \cdot {sin}^{2} ( \frac{Δ λ}{2} ) \qquad ( 1 )$$

$$c = 2 \cdot atan 2 ( \sqrt{a} , \sqrt{1 - a} ) \qquad ( 2 )$$

$$d = R \cdot c \qquad ( 3 )$$

where φ is latitude,
λ is longitude, and
R is earth's radius.

As an example, if the defect is classified as transverse cracks, additional detail is forthcoming on the methodology for classification, the classified defect is quantified to come up with distance apart (i.e., distance between the transverse cracks), and if that distance is greater than a first predetermined spacing (e.g., 40 inches), then a PASER score of 8 is assigned as seen in FIG. 8a. If, however, the spacing between transverse cracks is less than or equal the first predetermined spacing (e.g., 40 inches), but equal or greater than a second predetermined spacing (e.g., 10 inches) then a PASER score of 7 is assigned; if, however, the spacing is less than the second predetermined spacing (e.g., 10 inches) a PASER score of 6 is assigned, as provided in FIG. 8a. If the pavement surface is new (i.e., within a predetermined threshold of time from initial installation), or if there are no defects detected, a PASER score of 10 or 9 are assigned, respectively, as provided in FIG. 8c. FIG. 8d provides additional conditions for PASER score assignment when transverse or longitudinal cracks are detected.

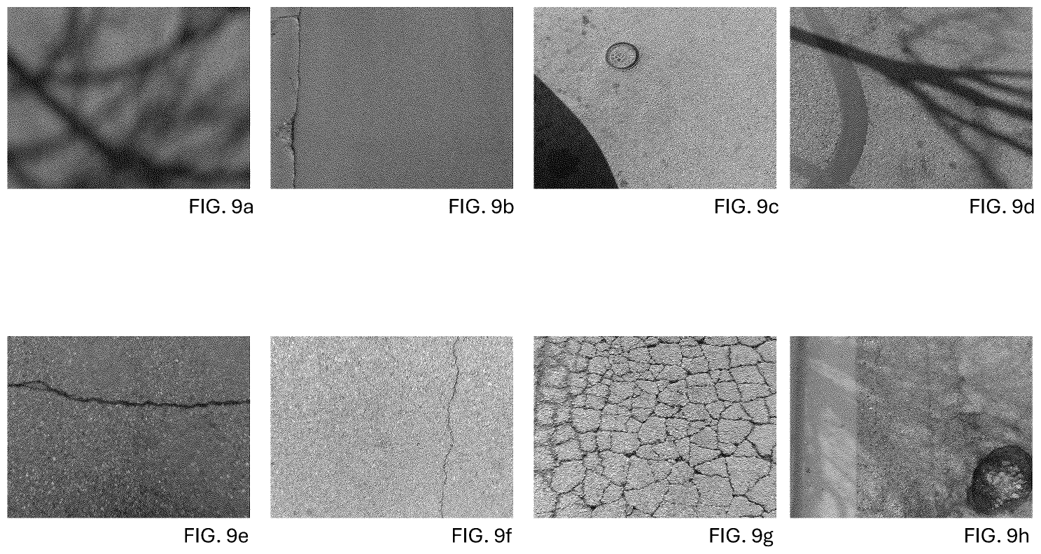

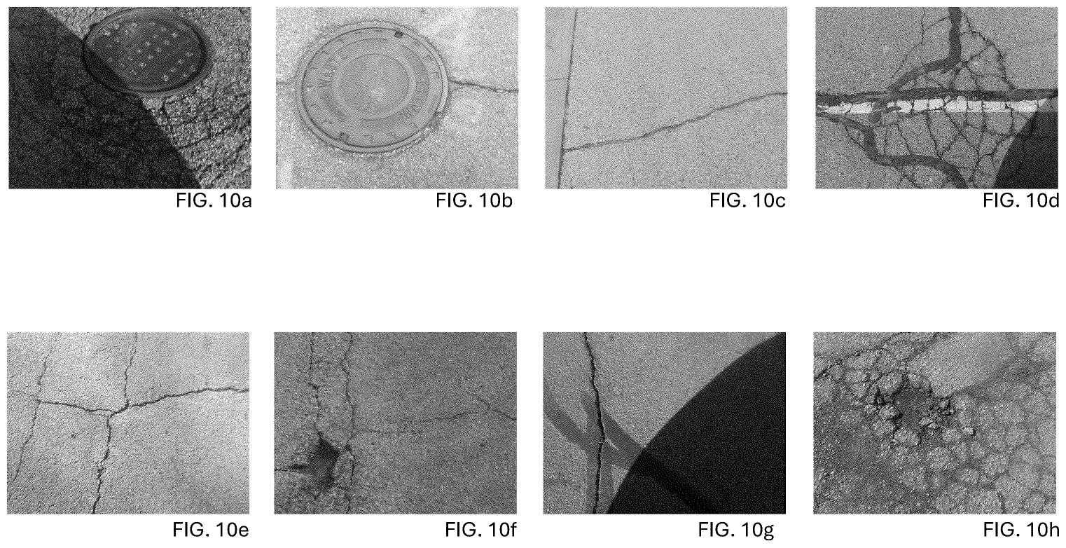

The pavement condition for each road segment is determined in the present disclosure through the process of defect classification. In the classification of pavement surface data, a deep learning-based approach is employed to classify the data. The pavement surface data, as depicted in FIGS. 9a-9h and 10a-10h, encompasses various distress types, including healthy surface, open joint, manhole, crack sealant, transverse, crack, longitudinal crack, alligator cracking, and pothole, in accordance with the PASER guidelines. While the current evaluation guidelines do not address the assessment of manholes, their influence on pavement conditions remains significant. For example, improper installation of manholes often leads to the development of cracks and sinking around utility covers. This can also result in the creation of depressions, elevated areas, or uneven surfaces, which contribute to the gradual deterioration of the asphalt over time. Moreover, when a manhole is not aligned with the adjacent surface elevation, it becomes challenging to compact the surrounding asphalt effectively. As a result, the asphalt may experience premature deterioration compared to the rest of the road. From the perspective of a comprehensive pavement management system, the present disclosure treats the manhole as a distinct class. However, as examples shown in FIGS. 10a-10h, an image of the pavement surface may exhibit multiple defects simultaneously.

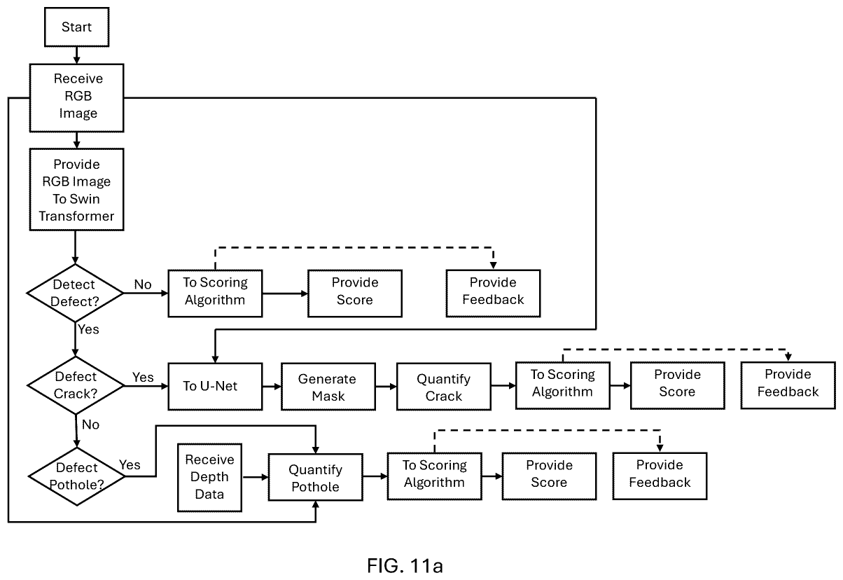

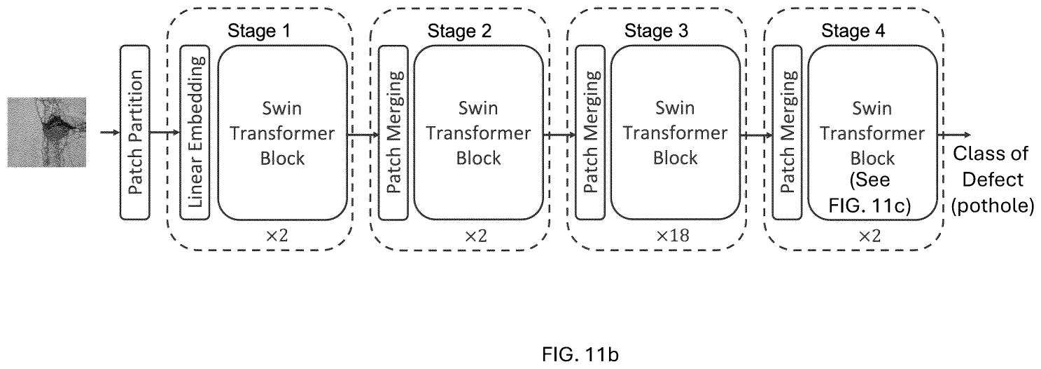

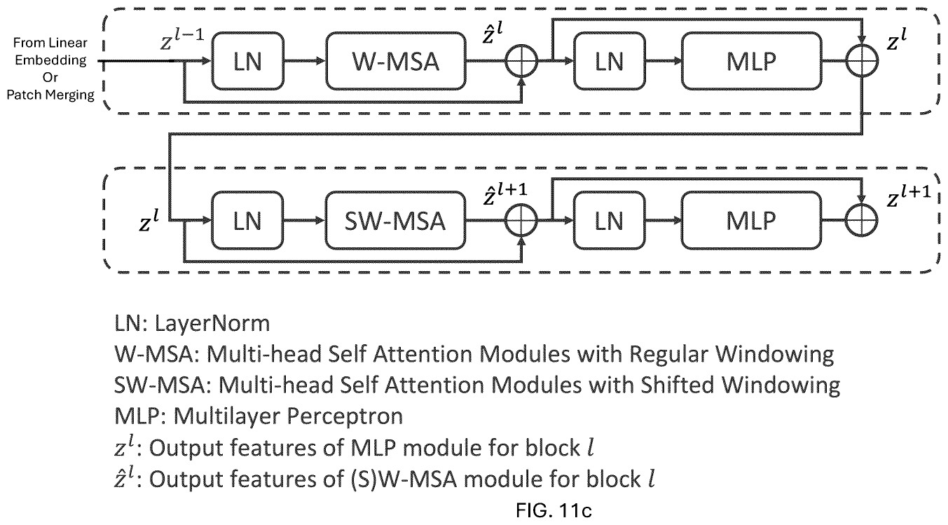

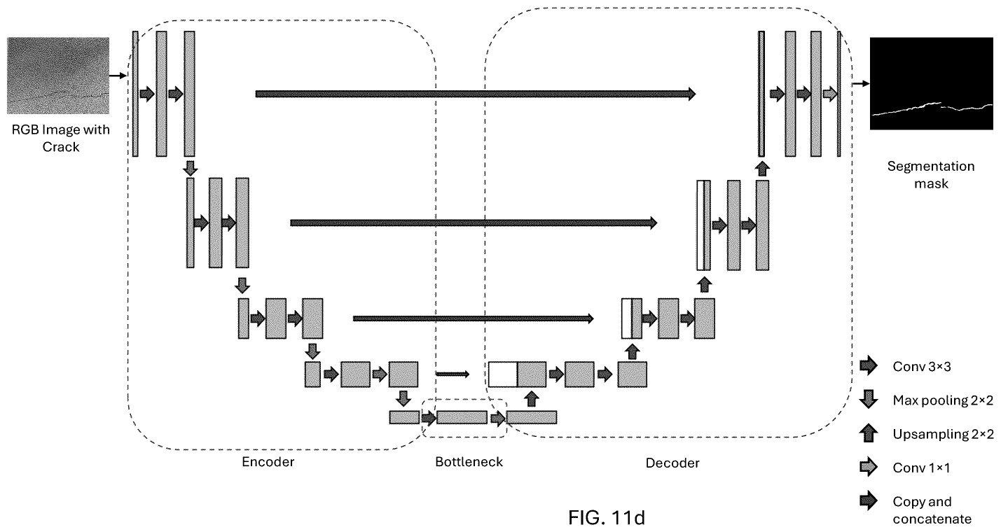

Referring to FIG. 11a, a high-level flowchart is provided which describes steps in the processing of the system of the present disclosure from receiving RGB images along with depth information, providing the RGB image to an image transformer (e.g., a Swin transformer—see FIGS. 11a and 11b) for detection and classification of road defects, if there is a road defect and it is a crack, then providing the RGB image to a neural network or a machine learning model (e.g., a U-Net—see FIG. 11d) to generate a mask and then using the mask to quantify the crack; if the road defect is a pothole, then providing the RGB image and depth information to a quantifier to quantify the pothole, and providing all of the above information (i.e., whether there is a road defect, if a crack then quantified information about the crack, if a pothole then quantified information about the pothole) to a scorer (e.g., a scoring algorithm based on predetermined rules (e.g., a PASER algorithm—see FIGS. 8a, 8b, 8c, and 8d)) to provide a score and then automatically provide feedback to a user for how to manage the road condition.

It should be appreciated that the neural networks and machine learning models discussed herein include components, e.g., weights, that are modified during a training phase with known inputs, e.g., images, and known outputs, e.g., detected and classified defects. Once the training phase has ended, then new previously unseen input data is provided to these models to generate the desired outputs. However, to continuously improve these models, from time to time a known previously unseen input may be provided and the output of the model compared to a known output, wherein the difference between the model output and the known output generates an error signal that can be provided as a feedback signal back to the model for further updating the components of the model. This feedback mechanism is known to a person having ordinary skill in the art.

Once the RGB image is received, according to the flowchart of FIG. 11a, the RGB image is provided to an image transformer (e.g., the Swin transformer shown in FIGS. 11b and 11c) which then i) detects whether there is any road defect at all, ii) if the road defect is a crack, iii) if the road defect is a pothole, or iv) if the road defect is some other condition such as manhole (which falls in the category of no defect). If the defect is a crack, then the RGB image is provided to a machine learning model (e.g., U-Net—see FIG. 11d) where a mask (i.e., a binary image where the background is one color, e.g., black, and the crack is another color, e.g., white) is generated to isolate the crack for further quantification (e.g., providing a centerline in the crack and quantifying distance to other cracks, and the width of the crack). Once the crack has been quantified, the information is passed on to a scorer (e.g., a scoring algorithm (e.g., a PASER algorithm—see FIGS. 8a, 8b, 8c, and 8d)) to automatically generate a score and feedback as to how to best treat the road defect. If the road defect is a pothole, then the RGB image along with depth information are provided to a quantifier (see, e.g., U.S. Pat. No. 9,196,048 to Jahanshahi et al., which as discussed below is incorporated by reference in its entirety into the present disclosure), which provides quantified information about the pothole. This information is then provided to the scoring algorithm (e.g., a PASER algorithm—see FIGS. 8a, 8b, 8c, and 8d) to automatically generate a score and feedback as to how to best treat the road defect,

For detection and classification, different deep learning networks including convolutional neural networks were investigated, however, the system of the present disclosure settled on a transformed known as Vision Transformer (ViT), known to a person having ordinary skill in the art for detection and classification of roadway defects. ViT is designed to divide an input image into a plurality of patches. Then ViT uses a serialization process on these patch to transform the patches into a vector. Next ViT maps the serialization into a smaller dimension with a matrix multiplication. These vectors are then processed by a transformer encoder. Referring to FIGS. 11b and 11c, the details of the ViT is provided. The ViT architecture is adapted to process visual data by dividing an input image into patches of equal size. These patches are then fed into a linear embedding layer and a standard Transformer encoder. The Swin Transformer, used herein, and also known to a person having ordinary skill in the art, builds upon the ViT architecture and introduces hierarchical feature maps by merging small-sized patches and progressively integrating neighboring patches within deeper transformer layers. The Swin transformer is a multi-scale transformer architecture designed for efficient processing of high-resolution images in computer vision tasks such as object detection and image classification. Additionally, the Swin Transformer introduced a novel self-attention mechanism characterized by a shifted window partitioning approach, effectively reducing computational and memory-intensive demands. The architecture of the Swin-small is shown in FIGS. 11b and 11c.

To classify the pavement defects, the Swin transformer network is first trained for classification. The training dataset includes a total of 17,000 images, with 80% allocated for training purposes and 20% for testing. To mitigate the potential impact of initialization uncertainties, a five-fold cross-validation is conducted. For each cross-validation, the validation and training sets were mutually exclusive. Each network was trained for 30 epochs using the Adaptive Moment Estimation (Adam) optimizer, with a learning rate of 0.0001, and a batch size of 16. Furthermore, the adjustable parameters for each network were optimized based on the respective pre-trained network that was initially trained using the ImageNet dataset. The training took place on a Linux server running Ubuntu 20.04, equipped with NVIDIA® RTX8000 GPUs. PyTorch was used to implement the network training.

TABLE 2
Distribution of the pavement surface data

| | Healthy | Open | | Crack |
|---|---|---|---|---|
| | Surface | Joint | Manhole | Sealant |
| Number of images | 2,287 | 2,170 | 1,180 | 2,328 |

| | Transverse | Longitudinal | Alligator | Potholes & |
|---|---|---|---|---|
| | Crack | Crack | Cracking | Patches |
| Number of images | 2,489 | 2,528 | 2,237 | 2,166 |

The Swin transformer includes a patch partition layer used to partition the input RGB image into small patches. In Swin Transformer, the image is divided into non-overlapping patches. These patches are treated as smaller regions of the input, making the computation more efficient. Each patch is flattened and passed through a linear embedding layer (a fully connected layer) to project the patch into a higher-dimensional space. This step transforms the patches into a set of vectors (tokens) that can be processed by the Swin Transformer layers. The core of the Swin Transformer includes Swin Transformer Blocks, which process the patch embeddings using self-attention. In the Swin Transformer, self-attention allows the model to analyze how different patches of an image relate to one another, helping the model understand local and global structures. The self-attention mechanism involves three key components that are learned during training: Query (Q), Key (K), and Value (V) vectors defined as provided below: Query (Q): Represents the current patch in the sequence and what it is looking for in other patches.
Key (K): Represents how each other patch in the sequence responds to a query.
Value (V): Represents the actual information stored at that position in the sequence.

The attention score is calculated as the dot product between the Query of one patch and the Key of every other patch in the sequence. This score determines how much attention should be paid to each patch. Finally, these attention weights are used to compute a weighted sum of the Value (V) vectors. This allows the model to aggregate information from other relevant patches in the sequence, based on their relationships.

Each of the above-referenced blocks includes the following sub-components:

### A) Window-Based Multi-Head Self-Attention (W-MSA)

In the Swin Transformer, attention is computed locally within small windows of the image. This helps reduce the computational cost and memory requirements.
Windowing: The image is divided into non-overlapping windows, and self-attention is applied only within each window.
Multi-head Self-Attention (MSA): The attention mechanism is applied using multiple heads.
Each head captures different aspects of the relationships between tokens within the window.

### B) Shifted Window-Based Multi-Head Self-Attention (SW-MSA)

To enable information exchange across different windows (since W-MSA operates only within non-overlapping windows), Swin Transformer introduces a shifted window mechanism. After performing attention within the original windows, the windows are shifted by a certain number of patches, and attention is performed again on the shifted windows. This allows cross-window connections, enabling the model to capture both local and global context more effectively.
Shift operation: The windows are shifted by half the window size in both spatial dimensions, ensuring that patches that were not in the same window in the first pass are now in the same window after the shift.
Multi-head self-attention is an extension where multiple sets of Q, K, and V vectors (called heads) are computed in parallel. Each head captures different relationships between elements in the sequence, allowing the model to focus on different aspects of the input.
The outputs of the different heads are concatenated and projected through another learned linear transformation to produce the final output.

### C) MLP Layer

After the attention mechanisms, each patch embedding is passed through a feed-forward neural network (MLP), which includes two fully connected layers with a non-linear GELU activation function in between.
MLP: Standard two-layer MLP with GELU activation. It helps refine the representations obtained from the attention mechanism.

### Layer Normalization and Residual Connections:

Each W-MSA and SW-MSA block is followed by a Layer Normalization (LN) operation to stabilize training. Residual connections are also added around the W-MSA/SW-MSA and MLP blocks to preserve information from earlier layers and improve model training dynamics.
LayerNorm (LN): Normalizes inputs to stabilize training.
Residual Connection: Adds input to the output of the block, allowing for better gradient flow and learning.

### D) Patch Merging Layer:

As one moves deeper into the Swin Transformer, the model progressively reduces the number of tokens by merging adjacent patches, which is akin to down-sampling in convolutional neural networks (CNNs). This is done to reduce computational complexity as the resolution decreases while allowing the model to capture larger-scale features.
Patch merging: Adjacent patches are concatenated and projected into a new feature space using a linear layer. This reduces the number of tokens while increasing the embedding dimension.

### Final Classification:

After several stages of Swin Transformer blocks, the final feature map is flattened and passed through a classification head. This head is a simple fully connected layer that produces the final output which is the defects classes.

Once the defects have been identified and classified, a neural network (a U-Net, known to a person having ordinary skill in the art) is used to quantify the defect. To quantify the cracks, the methodology of the present disclosure commences by segmenting the cracks present in the image. A U-Net, which is a type of neural network is employed for pixel-level segmentation. In the present disclosure, a binary semantic segmentation deep CNN (DCNN) is trained to classify a pixel as a crack or background. The training dataset includes 822 images while the testing dataset includes 88 images. Referring to FIG. 11d, a schematic is provided that shows various components of the U-Net of the present disclosure.

The U-Net's architecture includes two main parts:

Encoder: This part captures the context by learning deeper, more abstract representations of the input image.
Decoder: This part restores the spatial information, helping localize where objects are in the image.

The U-Net starts with an input layer that takes in an RGB image, where the input dimensions are typically (H×W×C) (Image Height×Image Width×Channels). Next, the encoder network is essentially a series of convolutional layers and max-pooling layers. Its job is to progressively reduce the spatial dimensions of the input image while increasing the depth (number of channels). This allows the network to capture more abstract and global features. The encoder repeats these convolution and max-pooling operations 4 times. At each downsampling step, the number of feature channels is increased to capture more complex features as the spatial resolution decreases. Next each encoder includes convolutional layers. These layers apply a series of convolutional filters to extract features from the image. The kernel size is 3×3, and they are typically followed by ReLU activation functions to introduce non-linearity. Next a max-pooling layer is applied. The role of the max-pooling layer is to downsample the feature maps by taking the maximum value in each 2×2 region (or other specified sizes). This reduces the spatial dimensions (height and width) of the feature map by half while retaining important features. At the bottom of the U-Net, there is a bottleneck layer that sits between the encoder and the decoder. This layer is the most abstract representation of the input image, where the spatial dimensions are at their smallest, and the number of feature channels is at its highest. The bottleneck usually includes two convolutional layers, followed by ReLU activations, without further downsampling. The decoder is the second half of the U-Net. Its job is to progressively upsample the feature maps back to the original resolution of the input image. Unlike the encoder, which reduces spatial resolution, the decoder increases it by combining local and global features to produce high-resolution outputs. The decoder repeats this up-convolution, concatenation, and convolution process for each step in the expanding path until the output resolution matches the original input image resolution. The decoder network starts with up-convolution (also called transposed convolution or deconvolution). This operation upsamples the feature maps, doubling their spatial dimensions while reducing the number of channels. This step reverses the downsampling done by max-pooling in the encoder. One of the key innovations in U-Net is the use of skip connections between the corresponding layers in the encoder and decoder paths. At each stage of upsampling, the feature maps from the encoder (with matching spatial resolution) are concatenated with the upsampled feature maps in the decoder. These skip connections allow the model to recover fine-grained spatial information that was lost during downsampling. After concatenation, the feature map is passed through two convolutional layers with ReLU activations. This step helps the model refine the upsampled feature maps by learning from both local (upsampled) and global (skip connection) features. The final layer in U-Net is a 1×1 convolution, which reduces the number of feature channels to the desired output class count. In crack image segmentation tasks, this is a binary output (crack vs. background), so there is one output channel per class. Next, output crack's segmentation mask are post processed to estimate crack width. With the segmentation mask, the crack width is calculated by skeletonized crack. The boundaries of the crack (the transition between white and black) and centerline of the crack are identified. The width of the cracks is subsequently calculated along the lines that are perpendicular to the centerline of the crack.

It is important to highlight that the PASER system only considers the width of cracks to offer a rudimentary evaluation of road conditions, without taking into account the unique characteristics of individual defects. In contrast, The system of the present disclosure surpasses the provision of a single PASER score by offering a comprehensive evaluation of defects and providing detailed information regarding pavement deterioration. The quantification of potholes has been extensively addressed in U.S. Pat. No. 9,196,048 to Jahanshahi et al., incorporated by reference in its entirety into the present disclosure, whereas the system of the present disclosure additionally quantifies cracks, thereby contributing to a more comprehensive understanding of pavement distress evaluation.

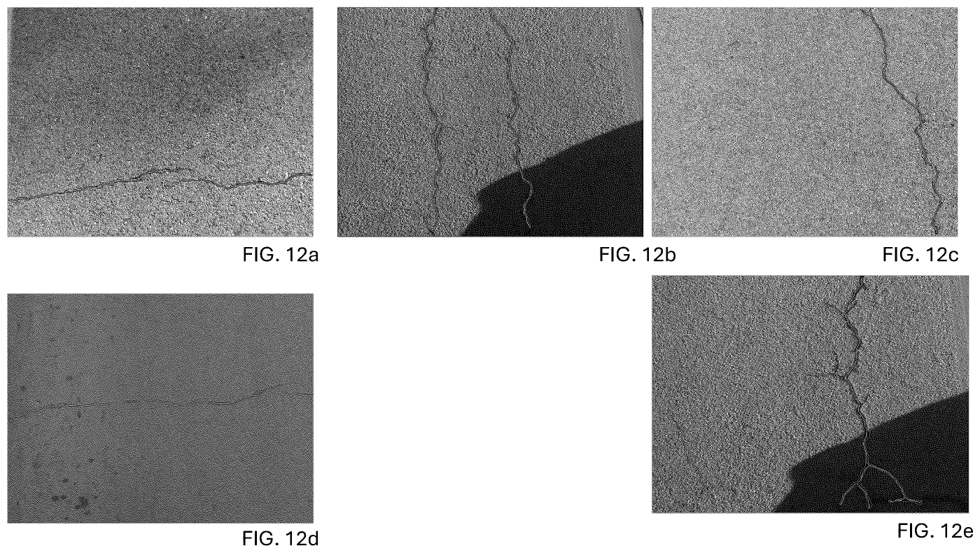

As partially discussed above, the system of the present disclosure quantifies defects by first segmenting the cracks present in the image. This segmentation process enables the estimation of crack widths. To automatically determine the width of cracks from the segmented crack, a centerline estimation algorithm is implemented with a fast marching method (FMM). The FMM technique is employed to solve the boundary value problem of the Eikonal equation:

$$F ( x ) \vert ∇ T ( x ) \vert = 1 \qquad ( 4 )$$

$$T ( x 0 ) = 0 \qquad ( 5 )$$

where x is the 2D coordinate of the image,
F(x) is the speed map, T (x) is the arrival time map,
∇ stands for gradient, and
x0 is a given start point. The crack thicknesses are then automatically computed along the lines that are orthogonal to the crack center line which is much faster than manual measurements. The center-line estimation of the crack is depicted in FIGS. 12a, 12b, 12c, 12d, and 12e, where for each crack the centerline is drawn out.

The evaluation metric used to assess network performance takes into account the number of true positives (TP), false positives (FP), and false negatives (FN) for each class. These metrics are aggregated to calculate precision, recall, and F1-score. Precision is an indicator that represents the ability to correctly classify positive instances (Eq. 6). Recall indicates the correct recognition of a class. Recall is defined as a ratio of true positive instances (TP) to all positive samples (Eq. 7). F1-score is a single metric used to evaluate both precision and recall (Eq. 8).

$$Precision = \frac{TP}{TP + FP} \qquad ( 6 )$$

$$Recall = \frac{TP}{TP + FN} \qquad ( 7 )$$

$${F}_{1} = 2 \times \frac{precision \times recall}{precision + recall} \qquad ( 8 )$$

Tables 3, 4, and 5 present a comparison of precision, recall, and F1-score for the performance of three networks that were used to evaluation in classifying various pavement defects including RsNet-152, EfficientNet-b7, and Swin Transformer. Interestingly, no significant differences are observed among the three networks. Among the three classification networks, RsNet-152 demonstrates the shortest processing time in terms of inference time per image, requiring only 143 ms. In comparison, EfficientNet-b7 requires 203 ms, and Swin-small takes approximately 185 ms. On the storage side, Swin-small requires a modest storage size of 192 MB. Conversely, ResNet-152 and EfficientNet-b7 require larger storage capacities of 228 MB and 250 MB, respectively. Considering real-time processing requirements, ResNet-152 stands out for its faster inference speed, while Swin-small gains recognition for its efficient memory usage. As mentioned above, in the system of the present disclosure, the Swin-small Transformer was selected as the backbone classification network for rating the PASER score.

TABLE 3
Mean (μ) and standard deviation(σ) of precision for different DCNN architectures

| | | | | Sealed | Transverse | Longitudinal | Alligator | |
|---|---|---|---|---|---|---|---|---|
| | Healthy | Manhole | Open Joint | crack | crack | crack | cracking | Potholes |
| ResNet-152 | 0.977 | 0.929 | 0.987 | 0.970 | 0.981 | 0.969 | 0.981 | 0.989 |
| | (0.0061) | (0.0135) | (0.0057) | (0.0049) | (0.0060) | (0.0099) | (0.0044) | (0.0056) |
| EfficientNet-b7 | 0.968 | 0.946 | 0.988 | 0.972 | 0.977 | 0.968 | 0.978 | 0.986 |
| | (0.0049) | (0.0102) | (0.0098) | (0.0109) | (0.0062) | (0.0130) | (0.0096) | (0.0029) |
| Swim-small | 0.980 | 0.945 | 0.987 | 0.973 | 0.973 | 0.964 | 0.969 | 0.984 |
| | (0.0073) | (0.0147) | (0.0059) | (0.0088) | (0.0030) | (0.0100) | (0.0115) | (0.0037) |

TABLE 4
Mean (μ) and standard deviation(σ) of recall for different DCNN architectures

| | | | | Sealed | Transverse | Longitudinal | Alligator | |
|---|---|---|---|---|---|---|---|---|
| | Healthy | Manhole | Open Joint | crack | crack | crack | cracking | Potholes |
| ResNet-152 | 0.981 | 0.972 | 0.973 | 0.978 | 0.971 | 0.966 | 0.978 | 0.985 |
| | (0.0051) | (0.0089) | (0.0103) | (0.0101) | (0.0057) | (0.0031) | (0.0061) | (0.0046) |
| EfficientNet-b7 | 0.979 | 0.953 | 0.978 | 0.976 | 0.972 | 0.972 | 0.978 | 0.975 |
| | (0.0086) | (0.0205) | (0.0097) | (0.0041) | (0.0057) | (0.0047) | (0.0046) | (0.0025) |
| Swim-small | 0.976 | 0.950 | 0.975 | 0.980 | 0.971 | 0.961 | 0.981 | 0.984 |
| | (0.0041) | (0.0186) | (0.0120) | (0.0057) | (0.0023) | (0.0090) | (0.0025) | (0.0048) |

TABLE 5
Mean (μ) and standard deviation(σ) of F1-score for different DCNN architectures

| | | | | Sealed | Transverse | Longitudinal | Alligator | |
|---|---|---|---|---|---|---|---|---|
| | Healthy | Manhole | Open Joint | crack | crack | crack | cracking | Potholes |
| ResNet-152 | 0.979 | 0.950 | 0.980 | 0.974 | 0.976 | 0.968 | 0.979 | 0.987 |
| | (0.0045) | (0.0070) | (0.0078) | (0.0051) | (0.0040) | (0.0046) | (0.0052) | (0.0042) |
| EfficientNet-b7 | 0.973 | 0.949 | 0.983 | 0.974 | 0.975 | 0.970 | 0.978 | 0.980 |
| | (0.0069) | (0.0118) | (0.0059) | (0.0052) | (0.0057) | (0.0074) | (0.0061) | (0.0021) |
| Swim-small | 0.978 | 0.948 | 0.981 | 0.977 | 0.972 | 0.963 | 0.975 | 0.984 |
| | (0.0044) | (0.0083) | (0.0068) | (0.0062) | (0.0013) | (0.0072) | (0.0056) | (0.0030) |

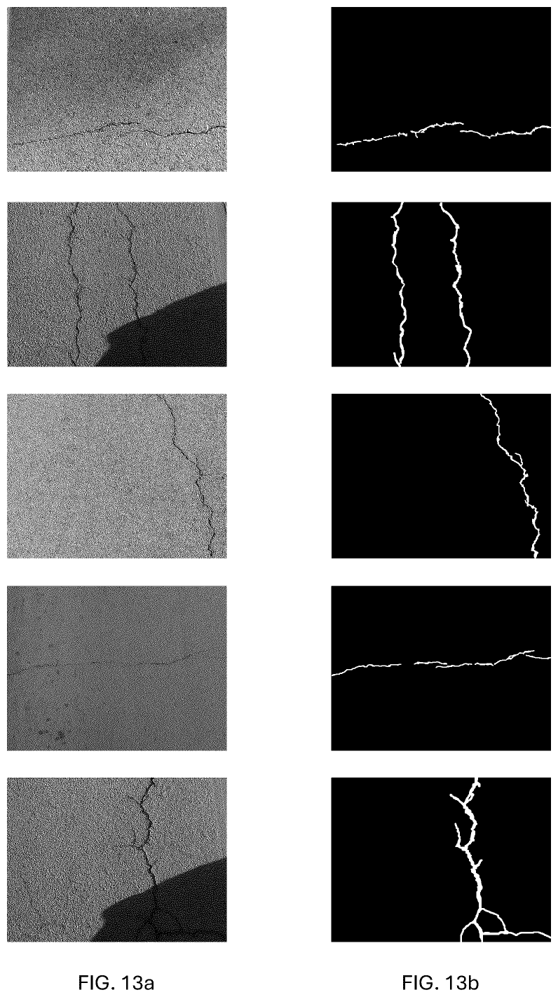

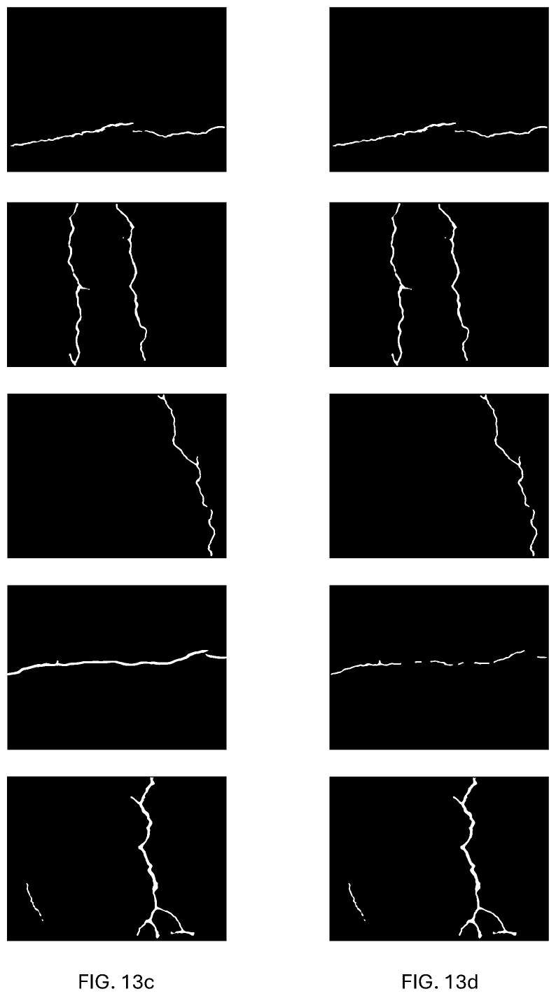

To validate the performance of the trained crack segmentation network, the Dice coefficient which is equal to the F1-score is used. The Dice coefficient of the trained crack segmentation network is 0.72. FIGS. 13a, 13b, 13c, and 13d demonstrate the side-by-side comparison between the ground truth and segmentation mask output generated by the U-Net model. The accompanying RGB images are presented in FIGS. 13a and 13b show the manually annotated mask. As shown in FIG. 13c, it can be observed that the segmentation mask can exhibit a tendency to overestimate the crack region. This overestimation can potentially lead to misleading results when estimating the width of the crack. To achieve a more precise representation of the crack's shape, a contour evolution approach is implemented. This approach involves the utilization of a dynamic curve or contour that progressively adjusts itself to conform to the desired crack boundary. The contour evolution process is initiated using the mask output generated by the U-Net, which serves as the initial contour. Through iterative updates and refinements, a final contour is obtained, accurately depicting the boundaries of the crack. As shown in FIGS. 13a and 13b, the side-by-side comparison between the segmentation mask output generated by the U-Net model and the refined segmentation mask obtained through active contour evolution is illustrated. FIGS. 13c and 13d display the original segmentation mask output from the U-Net model and the refined mask, respectively. The resulting refined mask, as illustrated in FIG. 13d, can be employed to estimate the crack width.

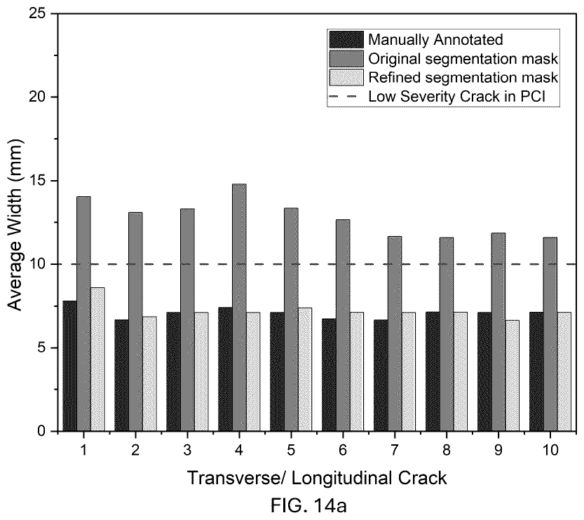

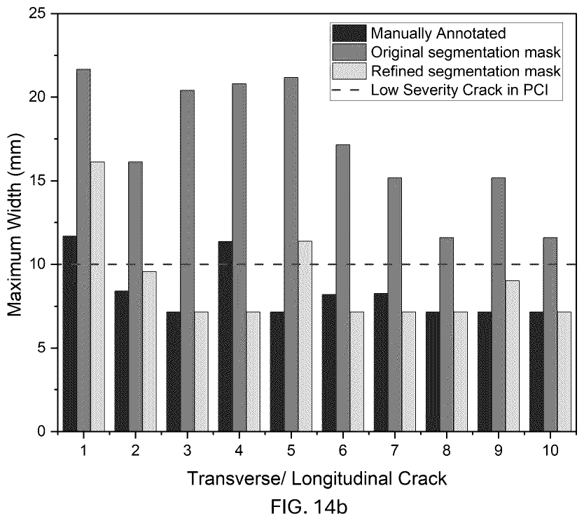

This present disclosure provides estimation of crack width for both transverse and longitudinal cracks. An analysis was conducted, which included ten transverse and longitudinal cracks. The quantification results obtained from the segmentation output generated by U-Net were compared to refined segmentation masks. Additionally, the results obtained from manual annotation of crack masks were also compared. In FIGS. 14a and 14b, estimations for the average and maximum crack width are illustrated, allowing for a comprehensive comparative analysis among the segmentation masks obtained directly from the U-Net model, the manually annotated outcomes, and the enhanced segmentation mask. The crack width was found to be overestimated by the initial U-Net segmentation, potentially leading to misleading evaluation results. For example, as shown in FIGS. 14a and 14b, the dashed line in the figure represents the threshold for a low severity level of cracks in PCI. The crack widths estimated by the initial U-Net segmentation mask exceeded the threshold for low severity level, whereas the crack widths indicated by the manually annotated and refined segmentation mask were narrower than the low severity threshold. It was observed that the crack width tended to be overestimated when using the segmentation mask output generated by U-Net.

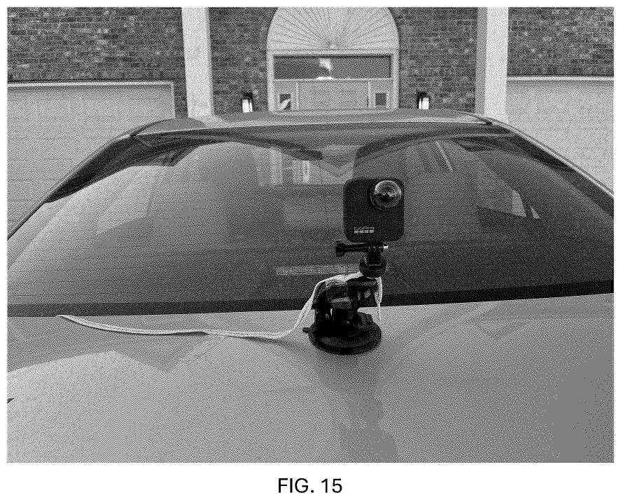

Based on the obtained results of classification and quantification, the evaluation of pavement conditions can be carried out using various pavement rating standards, such as the PCI and PASER systems. As an illustrative case study in this research, the PASER system was chosen. To validate the rating outcomes, a comparison is drawn between the PASER scores generated by the autonomous rating system and the ratings assigned manually. The manual rating process, as illustrated in FIG. 15, involves capturing videos using a GoPro™ camera attached to a vehicle or a handheld phone camera. Furthermore, a comparison is drawn between the system's output and historical data obtained from evaluations conducted six months earlier. These historical evaluations were conducted by student interns on behalf of the City of West Lafayette from October to November 2022. The comparison involving manual evaluation, the methodology of the present disclosure, and historical data is presented in Table 6.

TABLE 6
A comparison of PASER scores between manual evaluation, the
methodology of the present disclosure, and historical data.
The historical data, sourced from West Lafayette City, was
appraised by student interns between October and November 2022

| | | | PASER | PASER | PASER |
|---|---|---|---|---|---|
| | | Length | Score | Score | Score |
| Date | Road | (Miles) | Manual | (Pres. Discl.) | (Historical) |
| Feb. 20, 2023 | Northwestern Ave | 0.1 | 2 | 2 | 2 |
| Feb. 20, 2023 | N Salisbury St - 1 | 0.3 | 5 | 5 | 10 |
| Feb. 20, 2023 | N Salisbury St - 2 | 0.5 | 5 | 5 | 10 |
| Feb. 20, 2023 | N Salisbury St - 3 | 0.5 | 3 | 3 | 10 |
| Feb. 23, 2023 | John R Wooden Dr | 0.2 | 2 | 2 | N/A |
| Mar. 29, 2023 | 1st Street | 0.1 | 2 | 2 | 2 |
| Mar. 29, 2023 | 2nd Street | 0.1 | 2 | 2 | 2 |
| Apr. 2, 2023 | W Stadium Ave | 0.1 | 3 | 3 | 3 |
| Apr. 15, 2023 | Sylvia St | 0.1 | 3 | 3 | 3 |
| Apr. 15, 2023 | W Oak St | 0.1 | 2 | 3 | N/A |
| Apr. 15, 2023 | N University St | 0.1 | 4 | 4 | 4 |
| Apr. 15, 2023 | W State St | 0.1 | 4 | 4 | 7 |

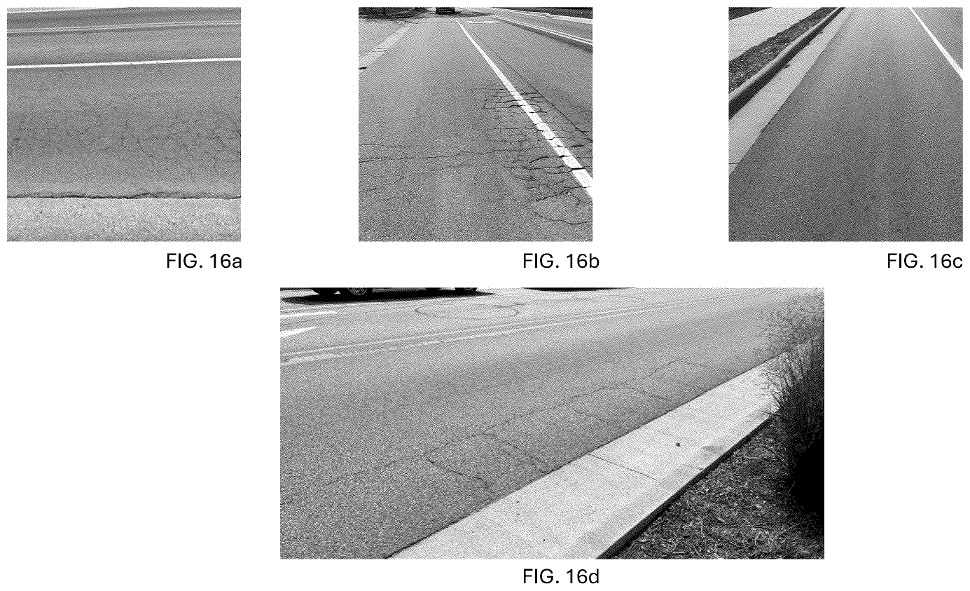

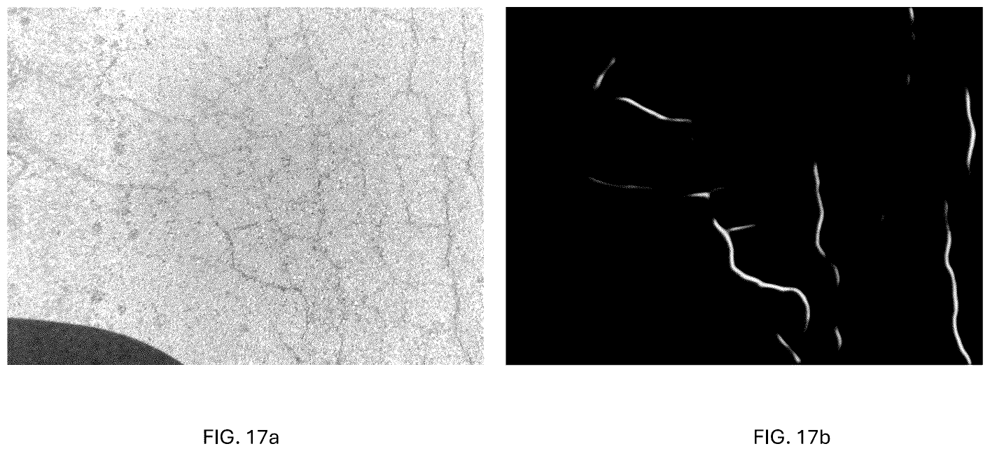

As seen in Table 6, a significant discrepancy exists in the PASER score for N Salisbury St when comparing historical data with the score rated by the system of the present disclosure. Over a span of nearly six months, the score experienced a significant decrease from 10 to 3 and 5. This substantial degradation is also evidenced by the results of manual evaluations. Depicted in FIGS. 16a, 16b, and 16c; these figures illustrate the presence of alligator cracking and edge cracks on the pavement. This discrepancy illustrates the importance of periodical evaluations of road sections where in a span of a few months the PASER score has significantly decreased. In other words, once every year or every other year evaluations of roads are not sufficient for prioritization of road defects. Similarly, the PASER score for W State St decreased from 7 to 4. In FIG. 16d, an edge crack has emerged on the pavement. On the other hand, variations in the PASER scores can be observed between manual evaluations and the results generated by the system of the present disclosure for W Oak St. This difference can be attributed to the intense lighting conditions during the data collection process on West Oak Street. These conditions led to reduced clarity in detecting alligator cracking within the RGB image shown in FIG. 17a. Consequently, inaccurate segmentation results and incorrect estimations of the alligator cracking area occurred, as shown in FIG. 17b.

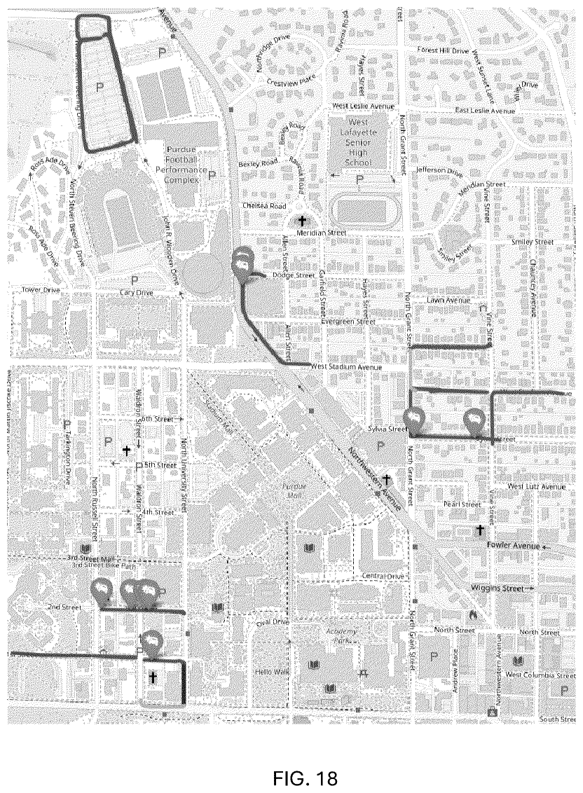

To better illustrate the condition of pavements, as shown in FIG. 18, the PASER score obtained from the system of the present disclosure is visually depicted on the map using a color-coded scheme. The color red indicates a PASER score range of 1 to 3, representing poor conditions that include alligator cracking and potholes. The color orange represents a PASER score of 4, indicating poor conditions without potholes. A range of 5 to 7 on the PASER score scale is denoted by the color blue, indicating fair conditions. Lastly, green is designated for segments that reflect good conditions, with a PASER score range of 8 to 10.

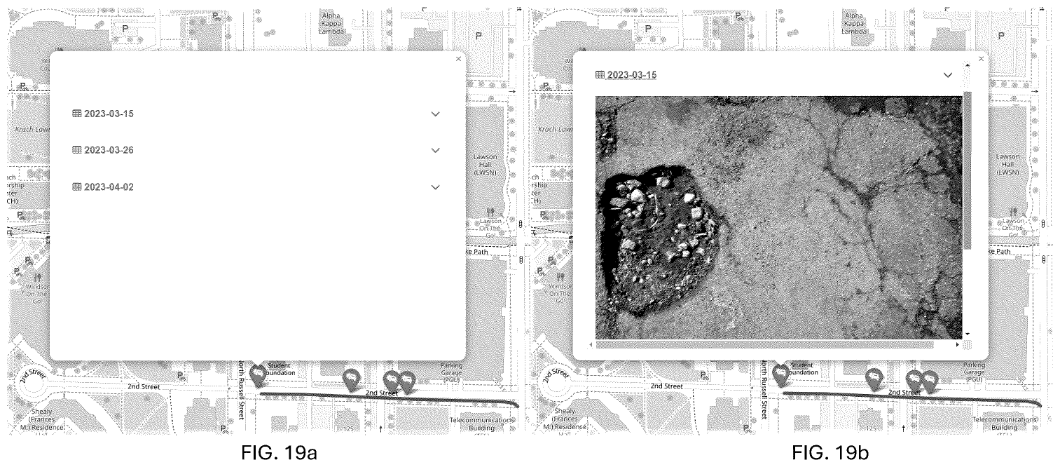

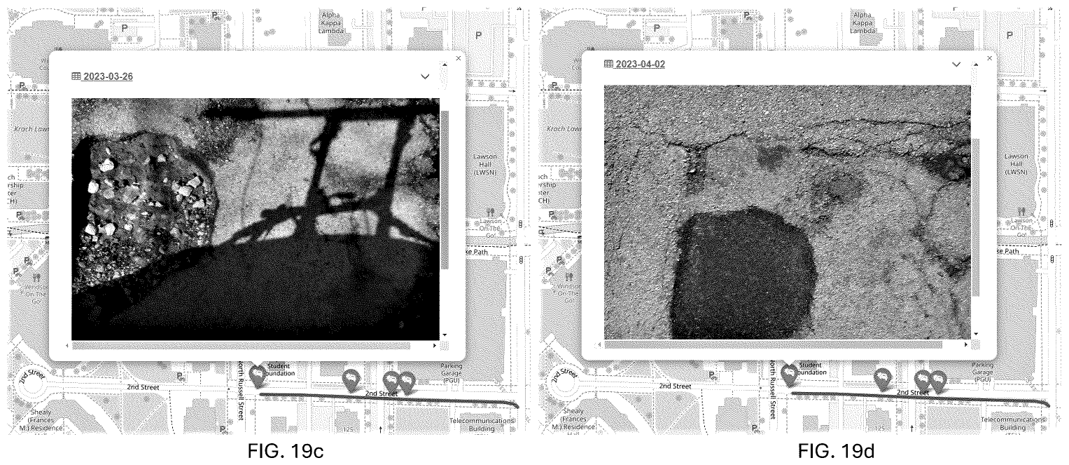

Furthermore, it is possible to visualize the evolution of detected defects directly on the map. This capability is exemplified in FIGS. 19a, 19b, 19c, and 19d where a specific example of pothole tracking is showcased. In FIG. 19a, the specific date of data collection is prominently displayed, while the corresponding defect conditions are described in the expanded view as shown in FIGS. 19b, 19c, and 19d. A comprehensive discussion of defect progression using crowdsourced data is provided in the following section. This visual representation effectively communicates the condition assessment of the road network, providing a clear understanding of the PASER scores derived from the developed rating system.

The data acquisition system developed in this study has significantly improved the efficiency of monitoring road conditions, allowing for faster, more frequent updates. The collection of pavement data can be performed on various vehicles on a weekly basis to collect crowdsourced data. Given the importance of this task, it is imperative to establish a reliable data management system. To achieve this goal, a robust database has been constructed to securely store information such as GPS coordinates, PASER scores, and images of detected defects on the pavement following the completion of each data collection session. Leveraging the capabilities of this database makes it feasible to retrieve and compare data collected on different dates. This enables comprehensive monitoring of the progression of defect deterioration over time.

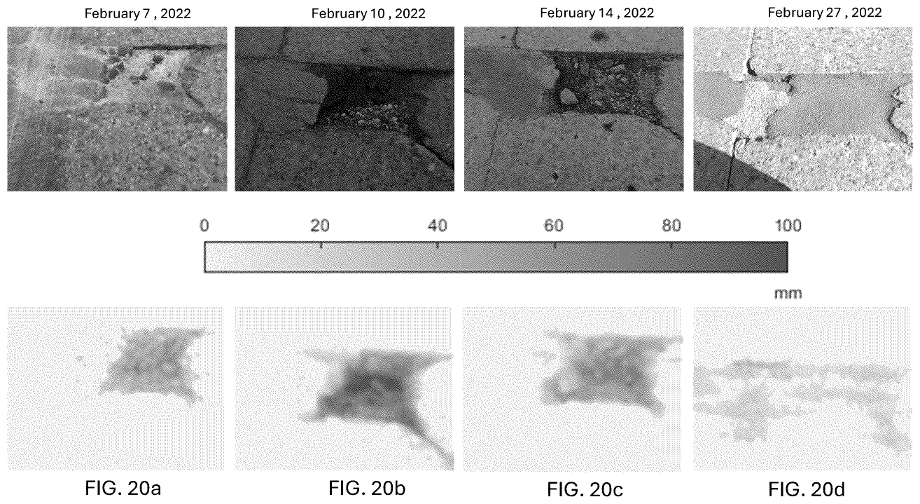

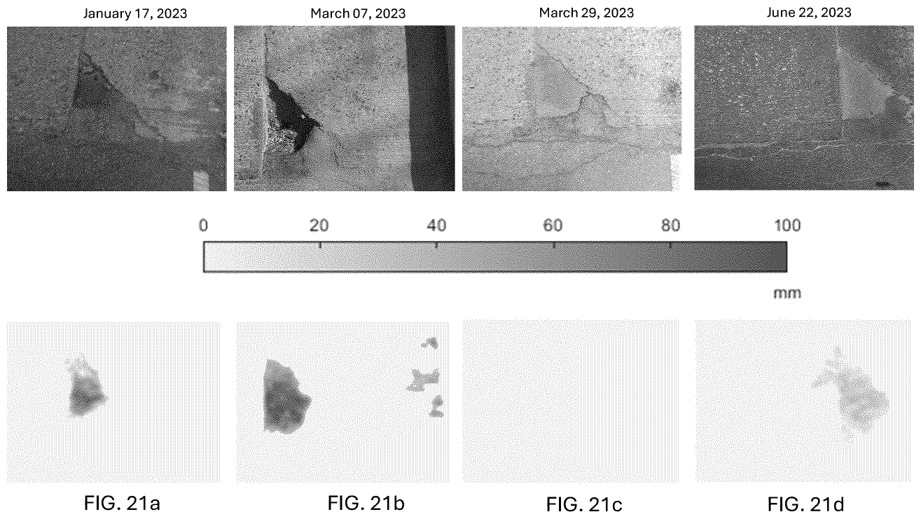

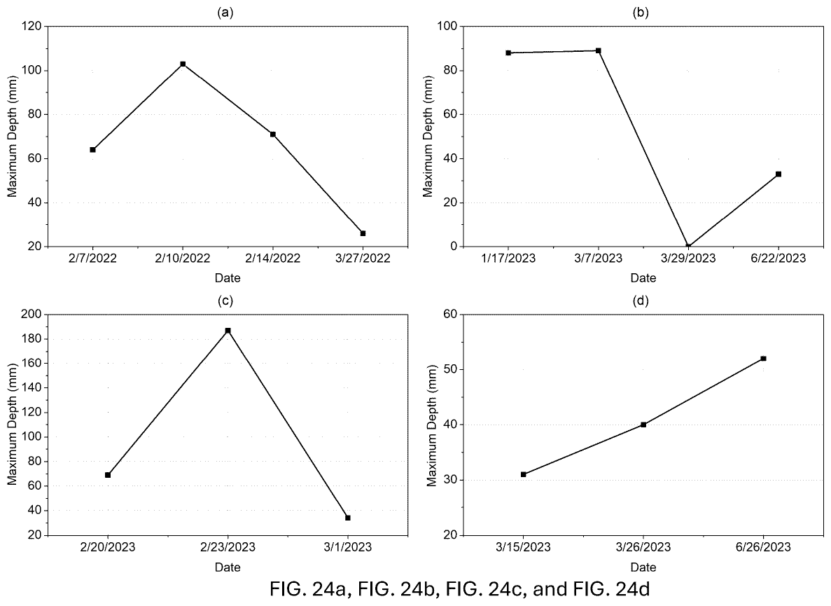

This study presents illustrative cases of the evolutionary changes observed in potholes, as shown in FIGS. 20a, 20b, 20c, 20d, 21a, 21b, 21c, 21d, 22a, 22b, 22c, 23a, 23b, and 23c. The first row in these figures shows the RGB image of the detected defect, while the second row displays the corresponding depth information. In the depth image, the darker areas indicate deeper regions. The corresponding change in depth values is presented in FIGS. 24a, 24b, 24c, and 24d. First, as depicted in FIGS. 20a, 20b, 20c, and 20d, the observed defects exhibit significant evolutionary changes. The initial detection of the pothole was recorded by the data acquisition system of the present disclosure on Feb. 27, 2022, following a snowstorm. Subsequently, the detected pothole exhibited progressive growth in both its area and depth. An increasing trend is shown in FIG. 24a. Additionally, the progress made in repairing the identified defect can also be tracked meticulously. Despite undergoing repairs on Mar. 27, 2022, the region experienced slight subsidence, as shown in FIG. 24a, where the depth value did not decrease to zero on that date. It highlights deficiencies in the quality of the restoration work. FIGS. 21a, 21b, 21c, and 21d are another set of example of evolutionary change. On Jan. 17, 2023, a pothole was initially detected. According to the data collected on Mar. 7, 2023, the detected pothole progressively enlarged and deepened. FIGS. 21b and 21d and FIG. 24b highlight the extent of its deterioration: both the area and depth of the pothole expanded over time. By Mar. 29, 2023, the pothole was repaired and fixed. The depth value decreased to zero, indicating that it was now flat, just like the adjacent road surface. However, on Jun. 22, 2023, as shown in FIG. 24b, the region sank again, indicating a potential structural issue with the pavement.

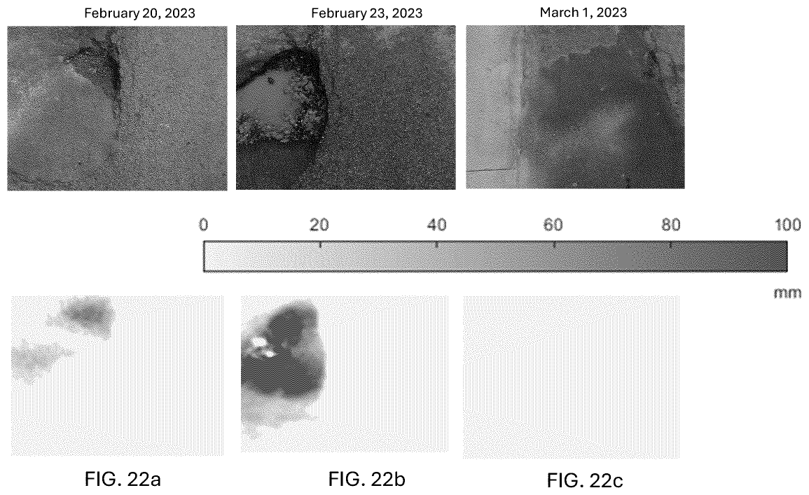

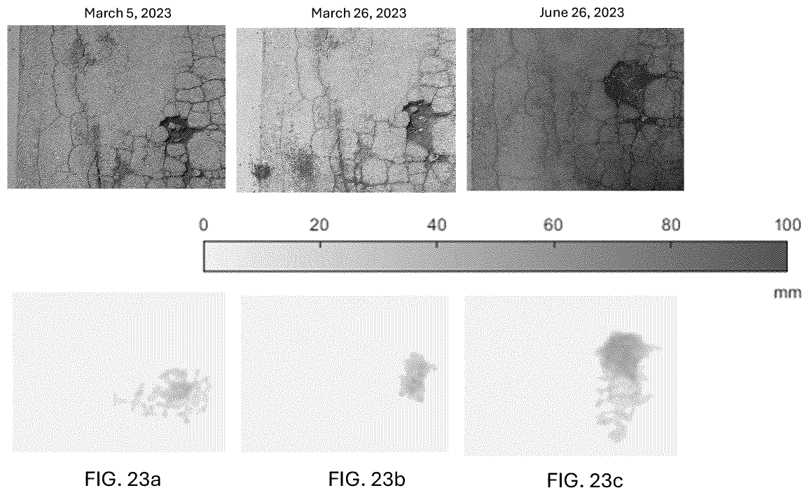

Moreover, the condition of a pothole can deteriorate rapidly within a short period due to severe weather conditions. An example of this is displayed in FIG. 22a. A small pothole with a poor patch was detected on Feb. 20, 2023. The detected defect rapidly grew larger and deeper after heavy rain. Although it was fixed immediately, the region slightly sank again, indicating that the quality of the temporary repair work was inadequate. FIGS. 23a, 23b, and 23c demonstrate the progression of a pothole from alligator cracking to a fully formed pothole. A small disintegration occurred in the region with severe alligator cracking, as shown in FIG. 23a, and no action was taken to repair it. Gradually, as shown in FIGS. 23b and 23c, it developed into a pothole, and the deterioration was ongoing. Moreover, the evolution of the defects is visualized on the maps (FIGS. 19a and 19b). By harnessing the functionalities of the established database along with visual evidence, it is possible to effectively monitor the condition of defects and assess the effectiveness of repair efforts.

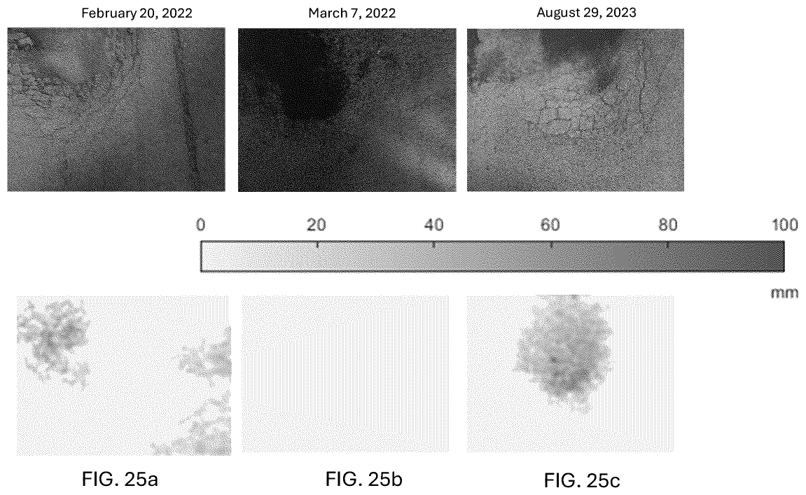

Furthermore, the system of present disclosure possesses the capability to track changes in PASER scores for specific road sections. Table 7 provides a detailed presentation of the PASER score variations observed in two distinct road segments. The corresponding RGB-D image pairs, illustrating Northwestern Ave, are depicted in FIGS. 25a, 25b, and 25c, with the top row showcasing RGB images and the lower row displaying depth information. As evidenced by the data in Table 7, there is a discernible fluctuation in PASER scores within a six-month period. The PASER score for Northwestern Ave exhibits a fluctuating trend. It was rated at 2 in February, then rose to 4 in March after pavement surface rehabilitation using slurry application. However, it regressed back to a PASER score of 2 in August indicating the inadequate quality of the repair work. In contrast, John R Wooden Dr saw its PASER score revert to 10 in August after undergoing a resurfacing job.

TABLE 7
Change of PASER scores obtained from system of the
present disclosure in specific road sections

| | PASER SCORE | | |
|---|---|---|---|
| | February 2023 | March 2023 | August 2023 |
| Northwestern Ave | 2 | 4 | 2 |
| John R Wooden Dr | 2 | 2 | 10 |

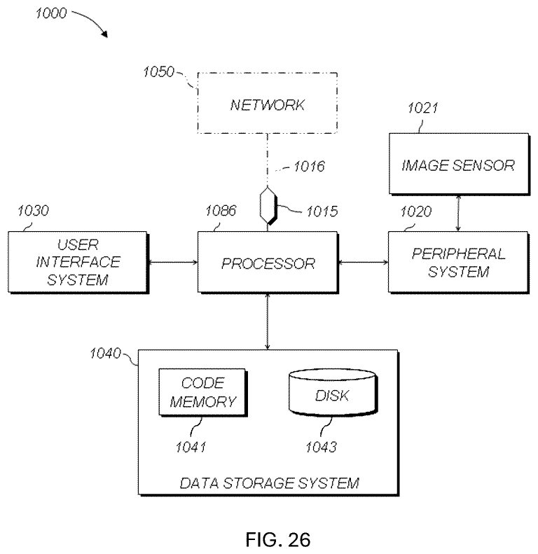

Referring to FIG. 26 a block diagram of a computer system is provided that can interface with the processing system of the present disclosure. As discussed throughout the present disclosure, at least one processor adapted to receive RGB images, detect one or more types of road defects if any, classify the one or more types of road defects if any, quantify the detected one or more types of road defects if any, score the detected one or more types of road defects if any, and provide recommendations as to how to manage the one or more types of road defects if any. FIG. 26 also includes the provisions for the associated computer system executing instructions maintained in a non-transitory memory to carry out the methods of the present disclosure. Referring to FIG. 26, an example of a such a computer system is provided that can interface with the above-discussed system. Referring to FIG. 26 a high-level diagram showing the components of an exemplary data-processing system 1000 for analyzing data and performing tasks described herein, and related components. The system includes a processor 1086, a peripheral system 1020, a user interface system 1030, and a data storage system 1040. The peripheral system 1020, the user interface system 1030 and the data storage system 1040 are communicatively connected to the processor 1086. Processor 1086 can be communicatively connected to network 1050 (shown in phantom), e.g., the Internet or a leased line, as discussed below. The imaging described in the present disclosure may be obtained using imaging sensors 1021 and/or displayed using display units (included in user interface system 1030) which can each include one or more of systems 1086, 1020, 1030, 1040, and can each connect to one or more network(s) 1050. Processor 1086, and other processing devices described herein, can each include one or more microprocessors, microcontrollers, field-programmable gate arrays (FPGAs), application-specific integrated circuits (ASICs), programmable logic devices (PLDs), programmable logic arrays (PLAs), programmable array logic devices (PALs), or digital signal processors (DSPs).

Processor 1086 can implement processes of various aspects described herein. Processor 1086 can be or include one or more device(s) for automatically operating on data, e.g., a central processing unit (CPU), microcontroller (MCU), desktop computer, laptop computer, mainframe computer, personal digital assistant, digital camera, cellular phone, smartphone, or any other device for processing data, managing data, or handling data, whether implemented with electrical, magnetic, optical, biological components, or otherwise. Processor 1086 can include Harvard-architecture components, modified-Harvard-architecture components, or Von-Neumann-architecture components.

The phrase “communicatively connected” includes any type of connection, wired or wireless, for communicating data between devices or processors. These devices or processors can be located in physical proximity or not. For example, subsystems such as peripheral system 1020, user interface system 1030, and data storage system 1040 are shown separately from the data processing system 1086 but can be stored completely or partially within the data processing system 1086.

The peripheral system 1020 can include one or more devices configured to provide digital content records to the processor 1086. For example, the peripheral system 1020 can include digital still cameras, digital video cameras, cellular phones, or other data processors. The processor 1086, upon receipt of digital content records from a device in the peripheral system 1020, can store such digital content records in the data storage system 1040.

The user interface system 1030 can include a mouse, a keyboard, a touchpad, another computer (connected, e.g., via a network or a null-modem cable), or any device or combination of devices from which data is input to the processor 1086. The user interface system 1030 also can include a display device, a processor-accessible memory, or any device or combination of devices to which data is output by the processor 1086. The user interface system 1030 and the data storage system 1040 can share a processor-accessible memory.

In various aspects, processor 1086 includes or is connected to communication interface 1015 that is coupled via network link 1016 (shown in phantom) to network 1050. For example, communication interface 1015 can include an integrated services digital network (ISDN) terminal adapter or a modem to communicate data via a telephone line; a network interface to communicate data via a local-area network (LAN), e.g., an Ethernet LAN, or wide-area network (WAN); or a radio to communicate data via a wireless link, e.g., WiFi or GSM. Communication interface 1015 sends and receives electrical, electromagnetic or optical signals that carry digital or analog data streams representing various types of information across network link 1016 to network 1050. Network link 1016 can be connected to network 1050 via a switch, gateway, hub, router, or other networking device.

Processor 1086 can send messages and receive data, including program code, through network 1050, network link 1016 and communication interface 1015. For example, a server can store requested code for an application program (e.g., a JAVA applet) on a tangible non-volatile computer-readable storage medium to which it is connected. The server can retrieve the code from the medium and transmit it through network 1050 to communication interface 1015. The received code can be executed by processor 1086 as it is received, or stored in data storage system 1040 for later execution.

Data storage system 1040 can include or be communicatively connected with one or more processor-accessible memories configured to store information. The memories can be, e.g., within a chassis or as parts of a distributed system. The phrase “processor-accessible memory” is intended to include any data storage device to or from which processor 1086 can transfer data (using appropriate components of peripheral system 1020), whether volatile or nonvolatile; removable or fixed; electronic, magnetic, optical, chemical, mechanical, or otherwise. Exemplary processor-accessible memories include but are not limited to: registers, floppy disks, hard disks, tapes, bar codes, Compact Discs, DVDs, read-only memories (ROM), erasable programmable read-only memories (EPROM, EEPROM, or Flash), and random-access memories (RAMs). One of the processor-accessible memories in the data storage system 1040 can be a tangible non-transitory computer-readable storage medium, i.e., a non-transitory device or article of manufacture that participates in storing instructions that can be provided to processor 1086 for execution.

In an example, data storage system 1040 includes code memory 1041, e.g., a RAM, and disk 1043, e.g., a tangible computer-readable rotational storage device such as a hard drive. Computer program instructions are read into code memory 1041 from disk 1043. Processor 1086 then executes one or more sequences of the computer program instructions loaded into code memory 1041, as a result performing process steps described herein. In this way, processor 1086 carries out a computer implemented process. For example, steps of methods described herein, blocks of the flowchart illustrations or block diagrams herein, and combinations of those, can be implemented by computer program instructions. Code memory 1041 can also store data, or can store only code.

Various aspects described herein may be embodied as systems or methods. Accordingly, various aspects herein may take the form of an entirely hardware aspect, an entirely software aspect (including firmware, resident software, micro-code, etc.), or an aspect combining software and hardware aspects. These aspects can all generally be referred to herein as a “service,” “circuit,” “circuitry,” “module,” or “system.”

Furthermore, various aspects herein may be embodied as computer program products including computer readable program code stored on a tangible non-transitory computer readable medium. Such a medium can be manufactured as is conventional for such articles, e.g., by pressing a CD-ROM. The program code includes computer program instructions that can be loaded into processor 1086 (and possibly also other processors), to cause functions, acts, or operational steps of various aspects herein to be performed by the processor 1086 (or other processors). Computer program code for carrying out operations for various aspects described herein may be written in any combination of one or more programming language(s), and can be loaded from disk 1043 into code memory 1041 for execution. The program code may execute, e.g., entirely on processor 1086, partly on processor 1086 and partly on a remote computer connected to network 1050, or entirely on the remote computer.

It should be appreciated that most of the selections, inputs, etc. are done in a virtual environment. Other than actual inputs provided by input devices, almost everything else in the present disclosure is conducted virtually. Thus, when a new scene is presented, the scene is a virtual based on a virtual construction.

It should be appreciated that while roadway defect detection is mentioned herein, the system of the present disclosure can be used on vehicles to detect, classify, quantify, score, and provide recommendations for defect present in other surface such as sidewalks, dirt roads, airport runways, etc.

Those having ordinary skill in the art will recognize that numerous modifications can be made to the specific implementations described above. The implementations should not be limited to the particular limitations described. Other implementations may be possible.

1. A system for managing road defects, comprising:
a first vision system, comprising:
at least one image capture device adapted to capture images of a roadway having a plurality of pixels for each image;
at least one depth sensor adapted to provide depth information for each pixel in the captured images;
a positioning sensor adapted to generate location information for each captured image;
a processing system having at least one processor adapted to execute instructions maintained on a non-transient memory and adapted to:
receive one or more captured images;
analyze the one or more captured images to thereby i) detect, and ii) classify one or more types of road defects from a plurality of predetermined road defects;
quantify the detected and classified one or more types of road defects to thereby generate quantified parameters associated with each of the one or more types of road defects;
score severity of each of the one or more types of road defects using a predetermined rule-based scorer based on the generated quantified parameters of the one or more types of road defects.

2. The system of claim 1, wherein the processor is further configured to provide a recommendation for fixing each of the one or more detected road defects based on a predetermined schedule of defect correction.

3. The system of claim 1, wherein the processing systems includes one or more of an extended expert system and a machine learning model.

4. The system of claim 1, wherein the at least one image capture device is a first red-green-blue-camera.

5. The system of claim 4, wherein the at least one depth sensor is a second red-green-blue cameras operated in concert with the first red-green-blue camera in a stereo vision manner to generate depth information.

6. The system of claim 4, wherein the at least one depth sensor is the first red-green-blue camera equipped with a depth sensor.

7. The system of claim 1, wherein the positioning sensor is a global positioning system sensor.

8. The system of claim 1, wherein the first vision system is coupled to a rear-side of a road-based vehicle.

9. The system of claim 8, further comprising a second vision system adapted to provide images and depth information of the roadway coupled to a front-side of the road-based vehicle.

10. The system of claim 9, wherein the captured images of the first vision system and the captured images of the second vision system are combined in a differential manner to account for road defects in sufficient close proximity less than a length between the first and the second vision systems.

11. A method for managing road defects, comprising:
capturing images and depth information from a roadway using a first vision system;
identifying position of the captured images;
processing the captured images by a processing system to i) detect, and ii) classify one or more types of road defects;
quantifying the one or more types of road defects to thereby generate quantification parameters by the processing system; and
scoring the severity of each of the one or more types of road defects using the processing system that includes a predetermined rule-based scorer based on the generated quantified parameters of the one or more types of road defects.

12. The method of claim 11, further comprising providing a recommendation for fixing each of the one or more detected road defects based on a predetermined schedule of defect correction.

13. The method of claim 11, wherein the processing systems includes one or more of an extended expert system and a machine learning model.

14. The method of claim 11, wherein the first vision system includes a first red-green-blue-camera and first depth sensor.

15. The method of claim 14, wherein the first depth sensor is a second red-green-blue cameras operated in concert with the first red-green-blue camera in a stereo vision manner to generate depth information.

16. The method of claim 14, wherein the first depth sensor is the first red-green-blue camera each equipped with a depth sensor.

17. The method of claim 11, wherein the identification of the position is based on using a global positioning system sensor.

18. The method of claim 11, wherein the first vision system is coupled to a rear-side of a road-based vehicle.

19. The method of claim 18, further comprising using a second vision system adapted to provide images and depth information of the roadway coupled to a front-side of the road-based vehicle.

20. The method of claim 19, wherein the captured images of the first vision system and the captured images of the second vision system are combined in a differential manner to account for road defects in sufficient close proximity less than a length between the first and the second vision systems.
